(19) United States
(12) Patent Application Publication
(10) Pub. No.: US 2016/0004389 A1
(43) Pub. Date: Jan. 7, 2016

(54) DISPLAY CONTROLLER, DISPLAY CONTROL METHOD, CONTROL PROGRAM, AND RECORDING MEDIUM

(71) Applicant: Sharp Kabushiki Kaisha, Osaka-shi, Osaka (JP)

(72) Inventors: Hiroyasu IWATSUKI, Osaka-shi (JP); Akiyoshi SATOH, Osaka-shi (JP)

(73) Assignee: Sharp Kabushiki Kaisha, Osaka-shi, Osaka (JP)

(21) Appl. No.: 14/770,503

(22) PCT Filed: Mar. 12, 2014
(86) PCT No.: PCT/JP2014/056530

§ 371 Date: Aug. 26, 2015

(30) Foreign Application Priority Data
Mar. 14, 2013 (JP) 2013-052398

(51) Int. Cl. G06F 3/0481; G06F 3/0484; G06F 3/0483; G06F 3/0485; G06T 11/60

(52) U.S. Cl. CPC G06F 3/0481; G06F 3/0485; G06T 11/60; G06F 3/0483; G06F 3/04842; G06F 3/04847; G06F 3/04845; G06F 2203/04805

(57) ABSTRACT

An information processing device (1) includes: an operation determination section (10) for receiving an operation to specify a range of a displayed web page; and a superimposed display processing section (12) for displaying a superimposed object so that the superimposed object is superimposed on the web page, the superimposed object (i) containing an image of the specified range and (ii) being movable on a display screen.

### TECHNICAL FIELD

The present invention relates to a user interface for browsing a web page.

### BACKGROUND ART

A user interface for comfortably browsing a web page has conventionally been developed. For example, a browser capable of displaying a plurality of web pages by switching tabs has been developed and widely used.

A user interface for more comfortably using an information processing device has also been developed. For example, a technique disclosed in Patent Literature 1 makes it possible to comfortably carry out, in an information processing device including a touch panel, a touch operation by (i) enlarging an image of an operation position at which the touch operation has been carried out and (ii) displaying the enlarged image so that the enlarged image is superimposed on the operation position. Meanwhile, a technique disclosed in Patent Literature 2 allows an image of a region specified as a copy or movement target to be copied or moved by displaying the image of the region as a selected object and moving the selected object to a desired page.

### CITATION LIST

### Patent Literature

Patent Literature 1

Japanese Patent Application Publication, Tokukai, 2012-043452 A (Publication Date: Mar. 1, 2012)

Patent Literature 2

Japanese Patent Application Publication, Tokukai, 2012-088807 A (Publication Date: May 10, 2012)

### SUMMARY OF INVENTION

### Technical Problem

Note here that pieces of information on which a user focuses are frequently scattered in a single web page, which typically contains various pieces of information. In a case where a web page is displayed by a conventional browser, a user needs to turn eyes thereof on different positions on a display screen so as to browse pieces of information on which the user focuses. In a case where the pieces of information are not displayed on a single screen, the user needs to repeatedly scroll-display the web page.

That is, the conventional browser has a problem such that it is difficult to allow a user to comfortably browse pieces of information which pieces are scattered at different positions in a single web page. Such a problem is shared by the case of a display of a web page and the case of a display of content in units of pages. The problem cannot be solved by the technique of Patent Literature 1 for enlarging and displaying a touch position. Patent Literature 2, which is the technique for displaying an image of a copy or movement target region as a selected object so as to facilitate editing of content, is not assumed to be applied to content used mainly for browsing, such as content containing a link.

The present invention has been made in view of the problems, and an object of the present invention is to provide, for example, a display control device capable of allowing a user to comfortably browse pieces of information which pieces are scattered at different positions in content.

### Solution to Problem

In order to attain the object, a display control section in accordance with an aspect of the present invention is a display control device for displaying, on a display screen in units of pages, content containing a link to another content, the display control device including: a receiving section for receiving an input to specify a range of the displayed content; and a superimposed display section for, when the receiving section receives the input, displaying a superimposed object so that the superimposed object is superimposed on the content, the superimposed object (i) containing an image displayed in the range specified by the input and (ii) being movable on the display screen.

### Advantageous Effects of Invention

The aspect of the present invention yields an effect of allowing a user to comfortably browse pieces of information which pieces are scattered at different positions in content.

### BRIEF DESCRIPTION OF DRAWINGS

FIG. 1 is a block diagram showing an example of a configuration of a substantial part of an information processing device in accordance with an embodiment of the present invention.

FIG. 2 illustrates how a superimposed display is carried out by the information processing device. (a) of FIG. 2 shows an example of a screen in which a range is specified. (b) of FIG. 2 shows an example of the screen in which an image of the range specified in (a) of FIG. 2 is displayed so as to be superimposed on a web page.

FIG. 3 shows that an original web page and a superimposed object carry out respective separate link operations. (a) of FIG. 3 shows an example of a screen in which a link has not been selected. (b) of FIG. 3 shows an example of the screen in which the link has been selected.

FIG. 4 shows an example of a screen in a state after a rotation of a superimposed object.

FIG. 5 shows an example of an operation to deform a superimposed object.

FIG. 6 shows an example of a screen in which a scrolling operation is carried out from the state of (b) of FIG. 2.

FIG. 7 shows an example of a screen displaying a menu of processes that can be carried out with respect to a superimposed object.

FIG. 8 shows another example of the screen displaying the menu of processes that can be carried out with respect to the superimposed object.

FIG. 9 illustrates a point of difference between a screen capture and a copy. (a) of FIG. 9 shows an example of a superimposed object which is to be screen-captured or copied. (b) of FIG. 9 shows an example of an image to be saved by the screen capture. (c) of FIG. 9 shows an example of text to be saved by the copy.

FIG. 10 shows a specific example of a background layer management table.

FIG. 11 shows a specific example of a superimposed layer management table.

FIG. 12 shows a specific example of a bookmark table.

FIG. 13 illustrates a map. (a) of FIG. 13 shows an example of setting of the map. (b) of FIG. 13 shows an example of a layer display in accordance with the map illustrated in (a) of FIG. 13.

FIG. 14 shows an example of how to specify, in accordance with reference coordinates, a touch position in a superimposed layer.

FIG. 15 is a flow chart showing an example of an object display process.

FIG. 16 is a flow chart showing an example of a superimposition setting process.

FIG. 17 is a flow chart showing an example of a display update process.

FIG. 18 is a flow chart showing an example of a touch operation handling process.

FIG. 19 is a flow chart showing an example of a deformation process.

FIG. 20 is a flow chart showing an example of a two-finger touch operation handling process.

FIG. 21 is a flow chart showing an example of a screen capture process.

FIG. 22 is a flow chart showing an example of a bookmark process.

FIG. 23 is a flow chart showing an example of a bookmark display process.

FIG. 24 is a flow chart showing an example of a bookmark page display process.

FIG. 25 is a flow chart showing an example of a copy process.

### DESCRIPTION OF EMBODIMENTS

### Embodiment 1

An information processing device (a display control device) 1 in accordance with Embodiment 1 is a device having a browser function of displaying a web page. The information processing device 1 enlarges and displays an image of a range so that the image is superimposed on the web page, the range having been specified in the displayed web page. Note that a web page refers to content on a network and a set of data displayed at one time by a browser.

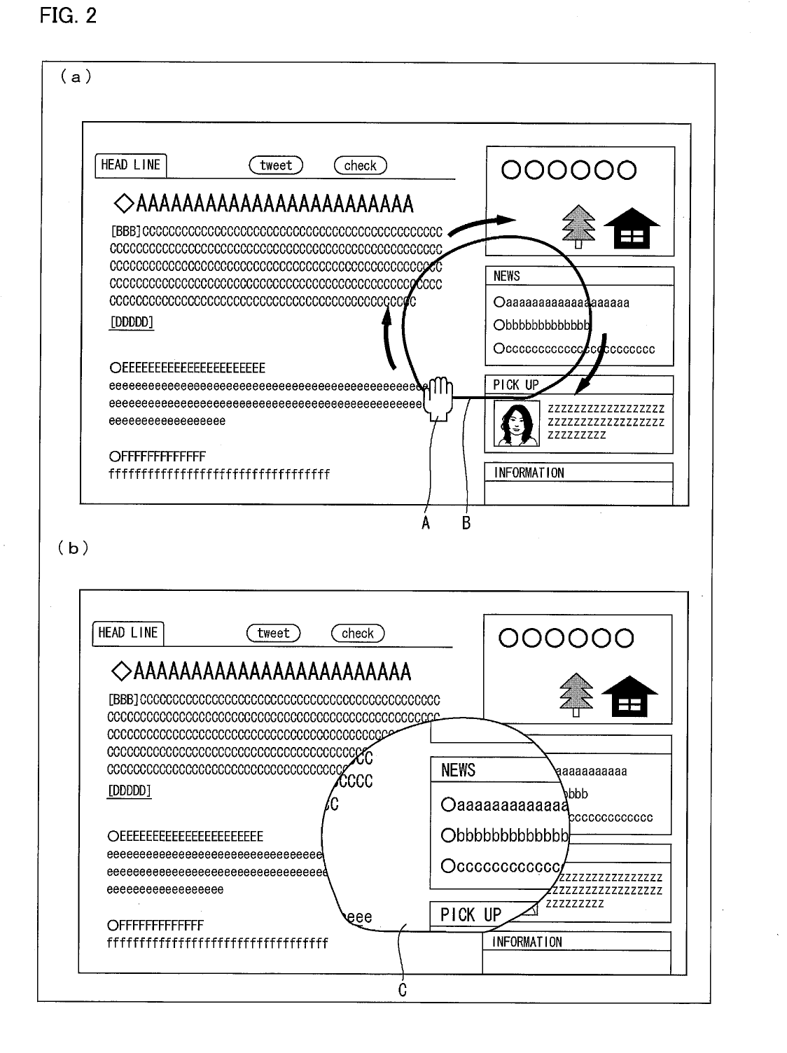

The following description discusses, with reference to FIG. 2, a screen to be displayed by the information processing device 1. FIG. 2 illustrates how a superimposed display is carried out. (a) of FIG. 2 shows an example of a screen in which a range is specified. (b) of FIG. 2 shows an example of the screen in which an image of the range specified in (a) of FIG. 2 is displayed so as to be superimposed on a web page.

(a) of FIG. 2 illustrates a state in which a range surrounded by a line B is specified by moving a cursor A on a displayed web page. When the range is specified, the information processing device 1 displays, as illustrated in (b) of FIG. 2, an image of the specified range so that the image is superimposed on an original web page which is originally displayed. Such an image that is displayed so as to be superimposed on the original web page is hereinafter referred to as a superimposed object. A superimposed object C illustrated in (b) of FIG. 2 includes an enlarged image of the specified range.

The superimposed object C operates separately from the original web page. Further, the superimposed object C can be moved to any position on a display screen. Note that, in a case where a double-tap operation (an operation to touch a display screen for a short time period two consecutive times) is carried out with respect to the superimposed object C, the information processing device 1 full-screen displays a web page corresponding to the superimposed object C (the original web page in the example of (b) of FIG. 2).

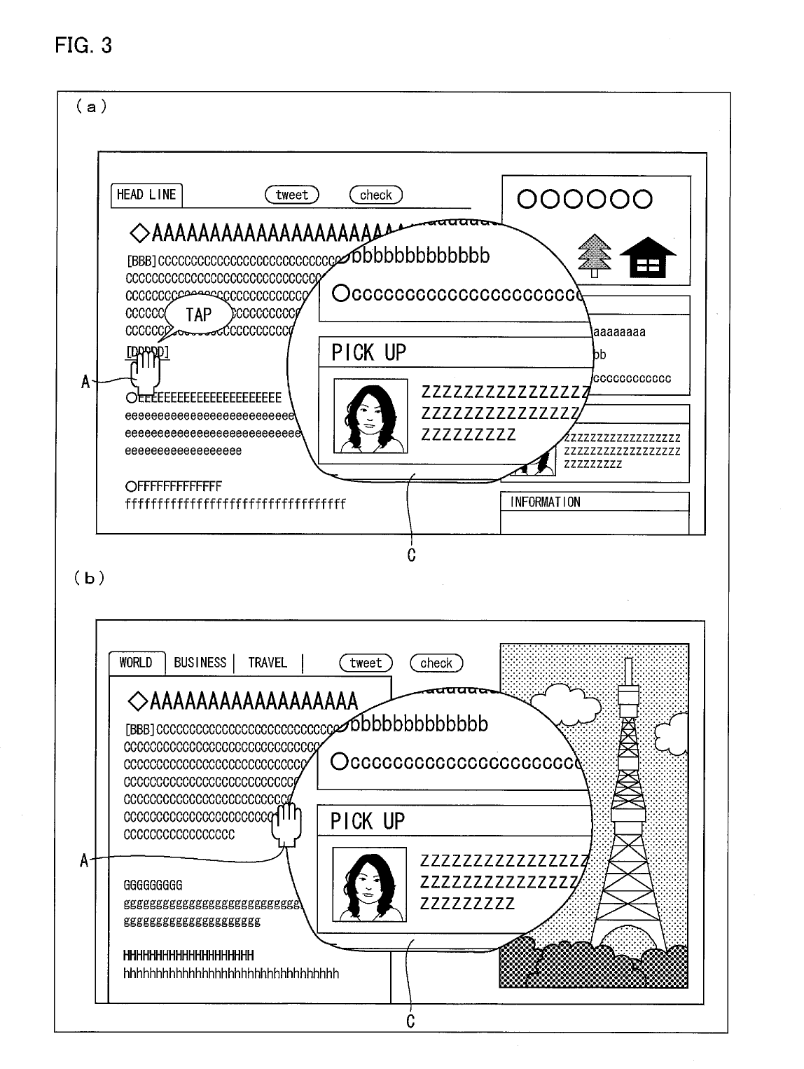

The following description discusses, with reference to FIG. 3, an operation to be carried out when a link in the web page is selected while the superimposed object is being displayed. FIG. 3 shows that the original web page and the superimposed object carry out respective separate link operations. (a) of FIG. 3 shows an example of the screen in which a link has not been selected. (b) of FIG. 3 shows an example of the screen in which the link has been selected.

In a case where, as illustrated in (a) of FIG. 3, in a state in which the superimposed object C is displayed, a tap operation is carried out with the cursor A placed on the link in the original web page, the information processing device 1 displays content at a link destination instead of the original web page as illustrated in (b) of FIG. 3. Meanwhile, the information processing device 1 does not change display contents of the superimposed object C even in a state in which the original web page is not displayed. Note that, in a case where a link in the superimposed object C is selected, the information processing device 1 does not change display contents of the original web page while displaying, in the superimposed object C, content at a link destination.

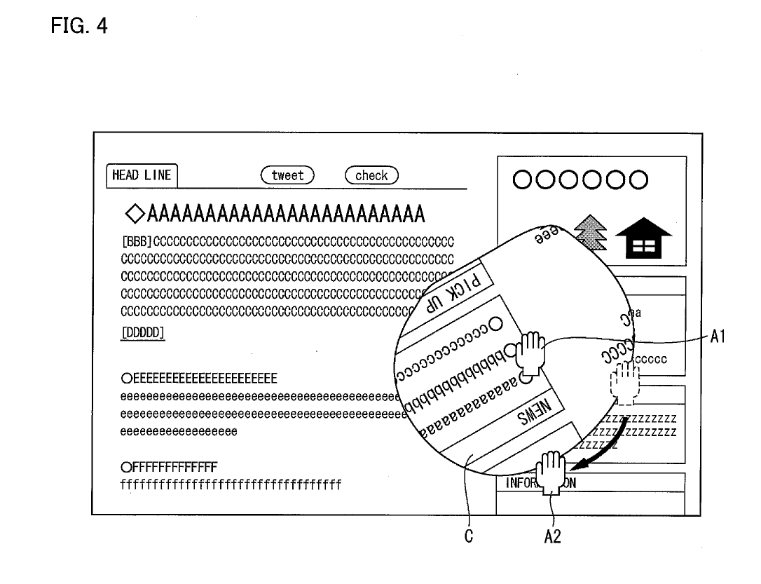

The superimposed object can change in direction by being rotated. The following description discusses a rotation of the superimposed object with reference to FIG. 4. FIG. 4 shows an example of the screen in a state after the rotation of the superimposed object.

As illustrated in FIG. 4, by dragging a cursor A2 in a desired direction in a state in which the superimposed object C is touched with a cursor A1 placed thereon, the superimposed object C is rotated in the direction in which the cursor A2 has been dragged, so that the superimposed object C can change in direction in which the superimposed object C is displayed. This causes the original web page and the superimposed object C to differ in direction of display (vertical direction of an image). Thus, without the need to change a direction of the display screen, a second user facing, across the information processing device 1, a first user of the information processing device 1 can also see the contents of the superimposed object C.

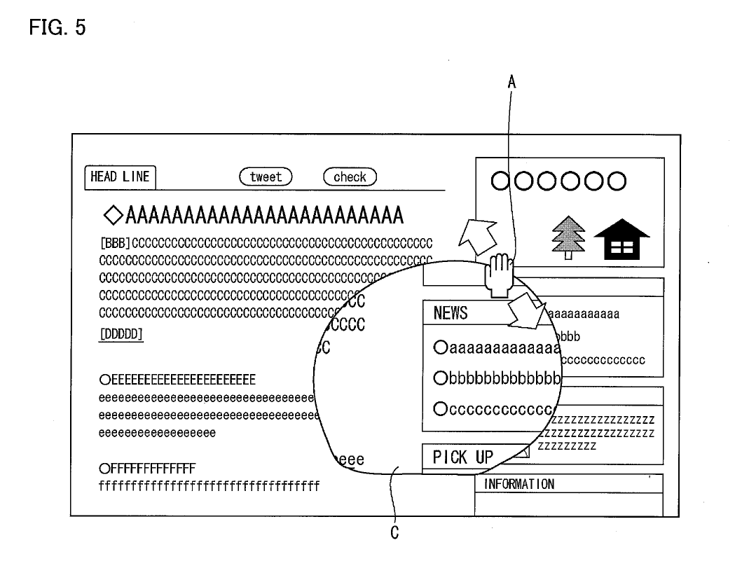

Further, the superimposed object can be deformed. The following description discusses deformation of the superimposed object with reference to FIG. 5. FIG. 5 shows an example of an operation to deform the superimposed object. As illustrated in FIG. 5, the superimposed object C can be deformed by placing the cursor A on an edge of the superimposed object C and then dragging the cursor A in a direction in which the superimposed object C is desired to be deformed. This makes it possible to enlarge, in a desired direction, a range in which the superimposed object C is displayed, and consequently to display necessary information in the superimposed object C.

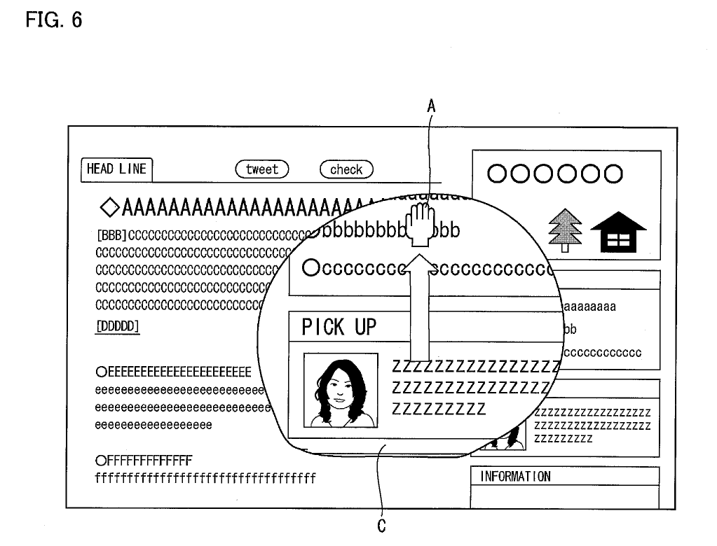

The superimposed object can be scroll-displayed separately from the original web page. The following description discusses scroll display of the superimposed object with reference to FIG. 6. FIG. 6 shows an example of the screen in which a scrolling operation is carried out from the state of (b) of FIG. 2. As illustrated in FIG. 6, the display contents of the superimposed object C can be scrolled by placing the cursor A on the superimposed object C and then dragging the cursor A in a direction (an upward direction in the example shown in FIG. 6) in which the display contents of the superimposed object C are desired to be scrolled. Note that, as illustrated in FIG. 6, the original web page does not change in display even in a case where such a dragging operation as described above is carried out with respect to the superimposed object C. Similarly, in a case where the dragging operation is carried out with respect to the original web page, only the original web page is scroll-displayed, and the superimposed object does not change in display contents.

[Operation with Respect to Superimposed Object]

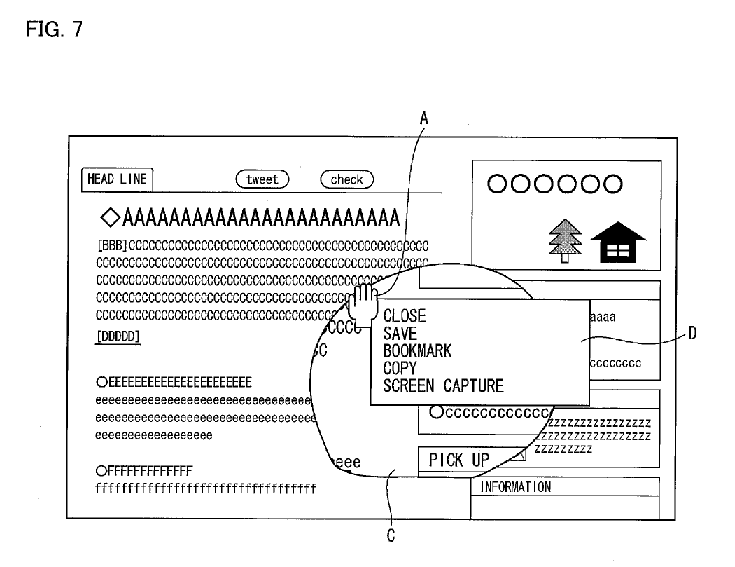

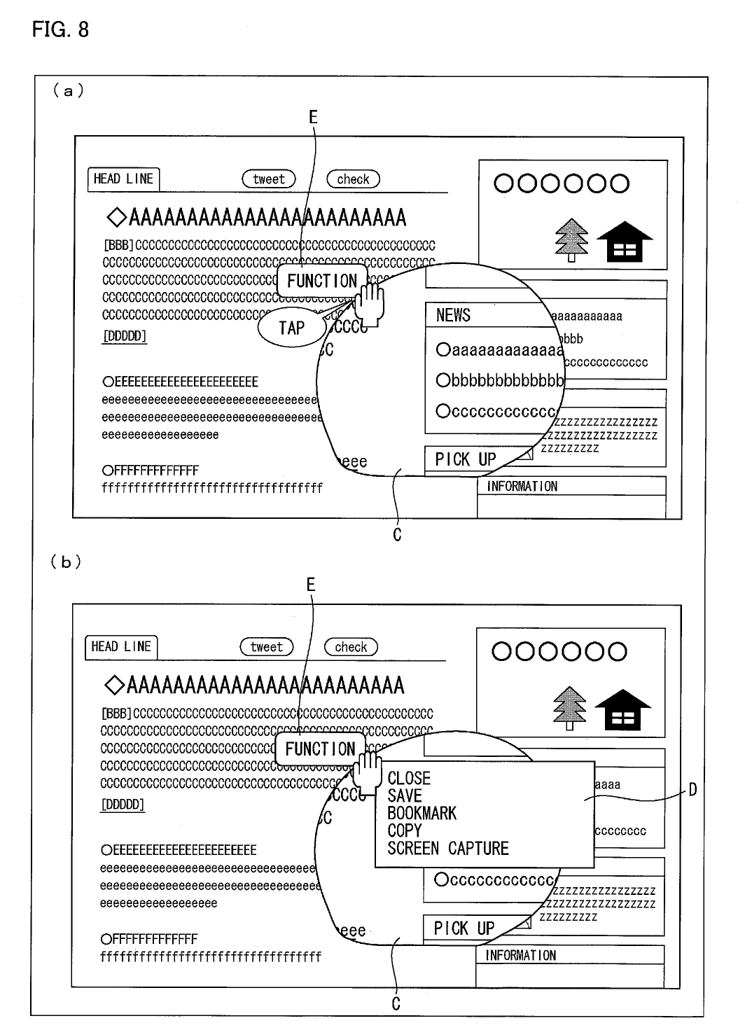

FIGS. 7 and 8 each show an example of the screen displaying a menu of processes that can be carried out with respect to the superimposed object. According to the example of FIG. 7, a menu D is displayed by subjecting the superimposed object C to a touch-and-hold operation to continue touching the superimposed object C for not less than a given time period. Meanwhile, according to the example of FIG. 8, a function button E as well as the superimposed object C is displayed as illustrated in (a) of FIG. 8, and the menu D illustrated in (b) of FIG. 8 is displayed when the function button E is tapped.

The menu D illustrated in each of FIGS. 7 and 8 includes the following items: “close,” “save,” “bookmark,” “copy,” and “screen capture.” The item “close” is used to end the display of the superimposed object C. The item “save” is used to save, in the form of a file, the original web page on which the superimposed object C is based. The item “bookmark” is used to register the superimposed object C so that the display of the superimposed object C can be resumed. The item “copy” is used to copy text contained in the superimposed object C. The item “screen capture” is used to save the superimposed object C in the form of an image.

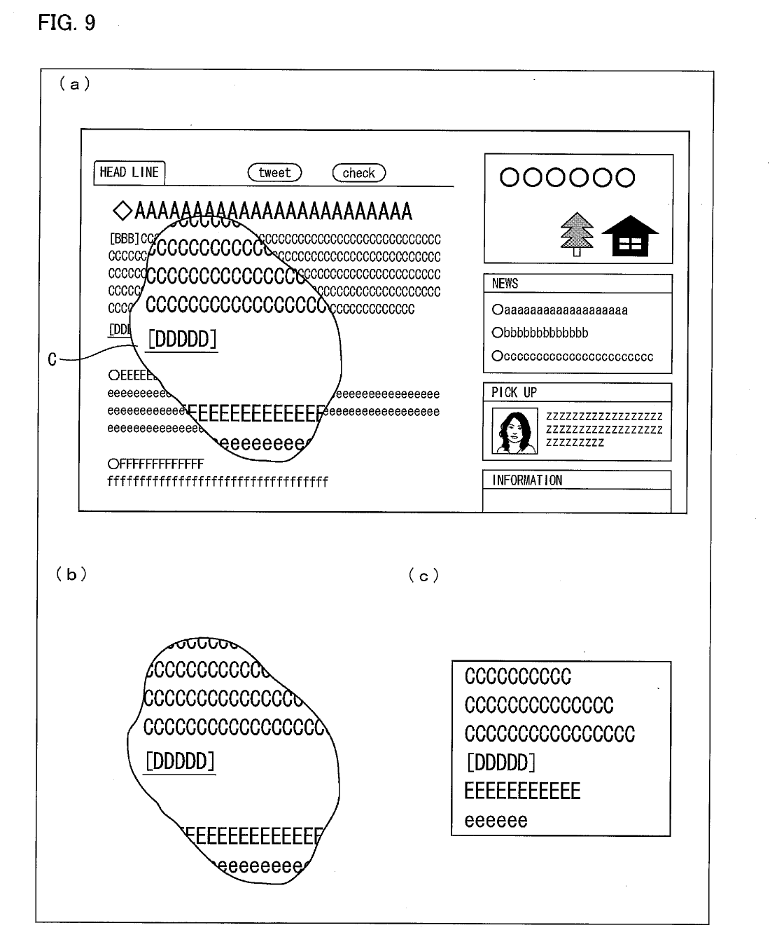

The following description discusses a point of difference between the items “screen capture” and “copy” with reference to FIG. 9. FIG. 9 illustrates the point of difference between the screen capture and the copy. (a) of FIG. 9 shows an example of the superimposed object which is to be screen-captured or copied. (b) of FIG. 9 shows an example of an image to be saved by the screen capture. (c) of FIG. 9 shows an example of text to be saved by the copy.

In a case where the superimposed object C illustrated in (a) of FIG. 9 is screen-captured, the image of the superimposed object C is saved as illustrated in (b) of FIG. 9. Meanwhile, in a case where the superimposed object C illustrated in (a) of FIG. 9 is copied, the text contained in the superimposed object C is copied as illustrated in (c) of FIG. 9.

[Configuration of Device]

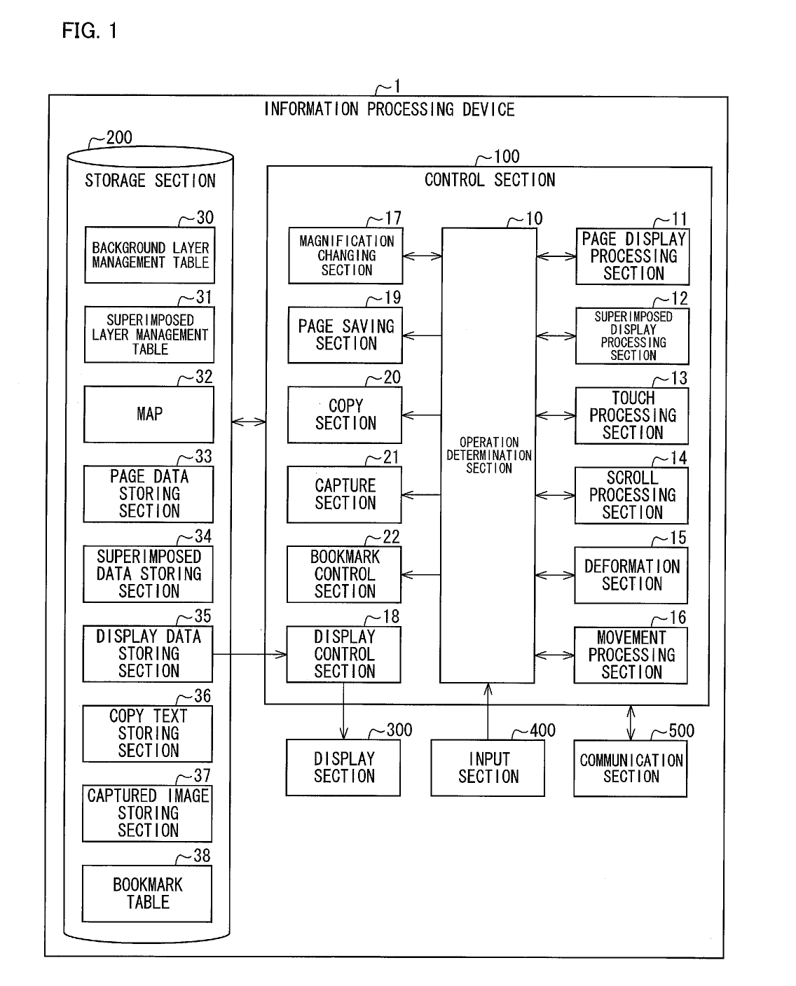

The following description discusses a configuration of the information processing device 1 with reference to FIG. 1. FIG. 1 is a block diagram showing an example of a configuration of a substantial part of the information processing device 1. As illustrated in FIG. 1, the information processing device 1 includes a control section 100, a storage section 200, a display section 300, an input section 400, and a communication section 500.

The control section 100 comprehensively controls functions of the information processing device 1. The control section 100 includes an operation determination section (a receiving section) 10, a page display processing section 11, a superimposed display processing section (a superimposed display section) 12, a touch processing section (a link section) 13, a scroll processing section (a scroll section) 14, a deformation section (a range changing section) 15, a movement processing section (a rotation section) 16, a magnification changing section 17, a display control section 18, a page saving section 19, a copy section 20, a capture section 21, and a bookmark control section (a storage processing section) 22.

The operation determination section 10 receives an input signal in accordance with an input operation received by the input section 400. Then, the operation determination section 10 specifies, in accordance with the input signal and an image being displayed in the display section 300, an operation which has been carried out by a user. The operation determination section 10 causes each of sections of the control section 100 to carry out a process in accordance with the specified operation.

The page display processing section 11 carries out a process for displaying the web page. The superimposed display processing section 12 carries out a process for displaying the superimposed object (see FIG. 2). These processes will be specifically described later.

The touch processing section 13 carries out a process in response to a touch operation. Specifically, in a case where a link to a website is displayed at a position at which a tap operation has been carried out, the touch processing section 13 renews an image at that position with an image at a link destination (see FIG. 3). In a case where a button is displayed at the position at which the tap operation has been carried out, the touch processing section 13 carries out a process associated with the button in advance (e.g., start a predetermined program).

The scroll processing section 14 carries out a process in response to a scrolling operation. Specifically, in a case where the scrolling operation (e.g., a predetermined operation such as a drag operation or a flick operation) is carried out, the scroll processing section 14 scroll-displays an image being displayed at a position at which the scrolling operation has been carried out. That is, in a case where the scrolling operation is carried out on the superimposed object, the scroll processing section 14 scroll-displays an image of the superimposed object (see FIG. 6). In a case where the scrolling operation is carried out on a web page displayed in a background, the scroll processing section 14 scroll-displays an image of the web page.

The deformation section 15 deforms the superimposed object in accordance with an input operation that is carried out to deform the superimposed object (see FIG. 5). Note that the deformation of the superimposed object changes a range of an image displayed in the superimposed object. This makes it possible to say that the deformation section 15 changes a range of the superimposed object.

The movement processing section 16 moves the superimposed object to a position in accordance with an input operation that is carried out to move the superimposed object. The movement processing section 16 changes a direction of the superimposed object on a display surface by rotating the superimposed object in a direction and at a rotation angle in accordance with an input operation that is carried out to rotate the superimposed object (see FIG. 4).

The magnification changing section 17 changes, in accordance with an input operation that is carried out to change a display magnification, a display magnification of an image displayed at a position at which the input operation is carried out. Specifically, the magnification changing section 17 changes a display magnification of an image of the superimposed object in response to the input operation that is carried out to change the display magnification on the superimposed object. Meanwhile, the magnification changing section 17 changes a display magnification of the web page in response to the input operation that is carried out to change the display magnification on the web page displayed in the background.

The display control section 18 controls the display section 300 so as to display an image. Specifically, the display control section 18 transmits data to the display section 300 so that the display section 300 displays the data, the data being stored in the display data storing section 35 (described later).

The page saving section 19 carries out a process for saving the web page in the form of a file. The copy section carries out a process for storing the text of the superimposed object (see (c) of FIG. 9). The capture section 21 carries out a process for storing the superimposed object in the form of an image (see (b) of FIG. 9). The bookmark control section 22 carries out a process related to bookmarking of the web page (the superimposed object). These processes can be carried out by, for example, the operation with respect to the menu D illustrated in each of FIGS. 7 and 8.

The storage section 200 is a storage device for storing various types of data to be used by the information processing device 1. The storage section 200 includes a background layer management table 30, a superimposed layer management table 31, a map 32, a page data storing section 33, a superimposed data storing section 34, a display data storing section 35, a copy text storing section 36, a captured image storing section 37, and a bookmark table 38.

The background layer management table 30 is information that the page display processing section 11 uses to display the web page. The superimposed layer management table 31 is information that the superimposed display processing section 12 uses to display the superimposed object. Note that the page display processing section 11 displays the web page on a layer different from a layer on which the superimposed display processing section 12 displays the superimposed object. The following description refers to (i) a layer to be processed by the page display processing section 11 as a background layer and (ii) a layer to be processed by superimposed display processing section 12 as a superimposed layer.

The map 32 is information indicative of which one of data of the background layer and data of the superimposed layer to display in the display section 300. The map 32 will be specifically described later.

The page data storing section 33 stores therein image data to be displayed in the background layer. The superimposed data storing section 34 stores therein image data to be displayed in the superimposed layer. The display data storing section 35 stores therein image data to be displayed in the display section 300. In a case where the data stored in the page data storing section 33 and the data stored in the superimposed data storing section 34 are stored in the display data storing section 35 in accordance with the map 32, the superimposed object is displayed so as to be superimposed on the web page. These storing sections each can be constituted by, for example, a VRAM (Video RAM).

The copy text storing section 36 stores therein text data to be copied by the copy section 20. The captured image storing section 37 stores therein image data to be captured by the capture section 21. The bookmark table 38 is information that the bookmark control section 22 uses to manage a bookmark.

The display section 300 is a display device for displaying an image in accordance with control of the control section 100. The input section 400 is an input device for receiving an input operation carried out by a user of the information processing device 1 and supplying the input operation to the control section 100. The following description discusses an example in which the display section 300 and the input section 400 are configured such that a display surface of the display section 300 serves as an input surface of the input section 400. That is, the following description discusses an example in which the information processing device 1 includes a touch panel. It is needless to say that a configuration of the display section 300 and the input section 400 is not limited to this example, provided that the display section 300 has a function of displaying the image and the input section 400 has a function of receiving the input operation. Further, the display section 300 and the input section 400 each can be an external device externally attached to the information processing device 1.

The communication section 500 is a communication device that the information processing device 1 uses to communicate with an external device. Specifically, the information processing device 1 causes the communication section 500 to receive content such as a web page via a network such as the Internet.

[Specific Example of Table]

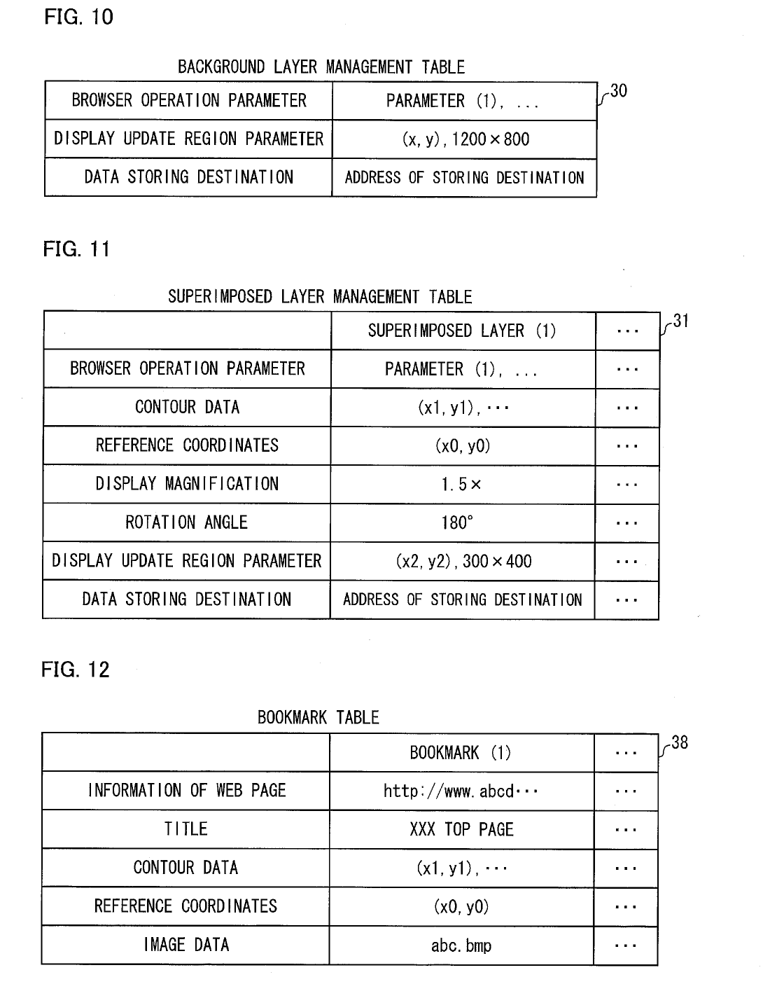

FIG. 10 shows a specific example of the background layer management table 30. The background layer management table 30 shown in FIG. 10 is a table in which a browser operation parameter, a display update region parameter, and a data storing destination are associated with each other.

The browser operation parameter is a parameter necessary for a display of a web page in the background layer and operation of the web page. The display update region parameter, which is a parameter indicative of a region to be updated on the display screen, is used to update a display in the background layer. According to the example shown in FIG. 10, a rectangular region to be updated is represented by (i) coordinates (x,y) of an upper left corner of the rectangular region and (ii) a width (1200 pixels) and a height (800 pixels). The data storing destination refers to an address of a destination in the page data storing section 33 at which destination a web page to be displayed in the background layer is stored.

FIG. 11 shows a specific example of the superimposed layer management table 31. The superimposed layer management table 31 shown in FIG. 11 is a table in which a browser operation parameter, contour data, reference coordinates, a display magnification, a rotation angle, a display update region parameter, and a data storing destination are associated with each other.

The browser operation parameter is a parameter necessary for a display of a web page in the superimposed layer and operation of the web page. The contour data is data indicative of a contour of the superimposed object. According to the example shown in FIG. 11, the superimposed layer management table 31 stores therein, in the form of contour data, all sets of coordinates constituting a trajectory of an operation to specify the range of the superimposed object. The reference coordinates are coordinates to be used as a reference for converting coordinates of a touch position on the display screen into coordinates of a touch position in the superimposed layer. The reference coordinates will be specifically described later. The display magnification is a parameter indicative of a magnification at which to display an image in the superimposed object with respect to an image of the original web page. The rotation angle is a parameter indicative of a rotation angle at which to rotate, with respect to the image of the original web page, the image to be displayed in the superimposed object. The display update region parameter, which is a parameter indicative of a region to be updated on the display screen, is used to update a display in the superimposed layer. According to the example shown in FIG. 11, a rectangular region to be updated is represented by (i) coordinates (x2,y2) of an upper left corner of the rectangular region and (ii) a width (300 pixels) and a height (400 pixels). The data storing destination refers to an address of a destination in the superimposed data storing section 34 at which destination content to be displayed in the superimposed layer is stored.

FIG. 12 shows a specific example of the bookmark table 38. The bookmark table 38 shown in FIG. 12 is a table in which information of a web page, a title, contour data, reference coordinates, and image data are associated with each other.

The information of the web page is information for accessing a bookmarked web page. According to the example shown in FIG. 12, the bookmark table 38 stores therein a URL (Uniform Resource Locator) of the bookmarked web page. The title refers to a title set for the bookmarked web page. These pieces of information are similar to those recorded during a bookmark in a commonly-used browser.

The bookmark table 38 includes not only the information of the web page but also pieces of information on the superimposed layer, which pieces are (i) contour data, (ii) reference coordinates, and (iii) image data, so as to reproduce a state in which the superimposed object is displayed. Note that the contour data and the reference coordinates, each of which is information indicative of the range of the superimposed object, are identical to those stored in the superimposed layer management table 31. The image data is data obtained by image-capturing the superimposed object.

[Map]

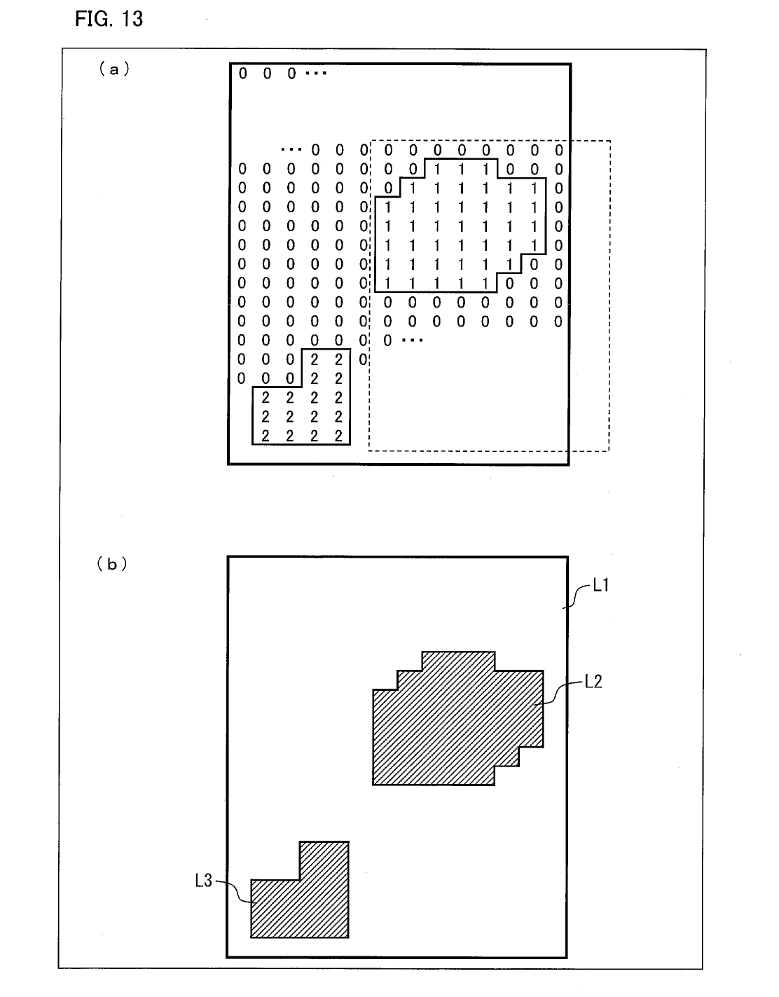

The following description discusses the map 32 with reference to FIG. 13. FIG. 13 illustrates the map 32. (a) of FIG. 13 shows an example of setting of the map 32. (b) of FIG. 13 shows an example of a layer display in accordance with the map 32 illustrated in (a) of FIG. 13. In (a) of FIG. 13, a range of pixels whose data is stored in the superimposed data storing section 34 is shown by a broken line.

According the map 32, “transmissive”, which is an attribute for displaying data of the background layer, or “superimposed”, which is an attribute for displaying data of the superimposed layer, is set for each of pixels constituting an image to be displayed. More specifically, a pixel having the transmissive attribute is set to have a value of “0”, and a pixel having the superimposed attribute is set to have a value of n (n is an integer not less than 1). According to the example shown in (a) of FIG. 13, a value of “0”, “1”, or “2” is set for each of the pixels. The information processing device 1 displays data of an identical layer in pixels for which an identical value is set.

That is, as illustrated in (b) of FIG. 13, in a case where the map 32 illustrated in (a) of FIG. 13 is used, an image L1 of the background layer is displayed in pixels for which the value of “0” is set. An image L2 of the superimposed layer is displayed in a case where a display is carried out in accordance with data of pixels which data is stored in the superimposed data storing section 34 and for which the value of “1” is set. Similarly, an image L3 of another superimposed layer is displayed in pixels for which the value of “2” is set.

Since the map 32 thus shows a region in which the data of the pixels of the superimposed layer needs to be displayed, only a part of a web page in the superimposed layer can be displayed with reference to the map 32 so as to be superimposed on a web page in the background layer. That is, according to the information processing device 1, in a case where an operation to specify a range of a web page is carried out, that web page is opened in a new layer (a superimposed layer). Then, the superimposed object is displayed by screen-displaying, in accordance with the map 32, only a part of the newly opened web page which part corresponds to the specified range.

[How to Specify Touch Position in Superimposed Layer in Accordance with Reference Coordinates]

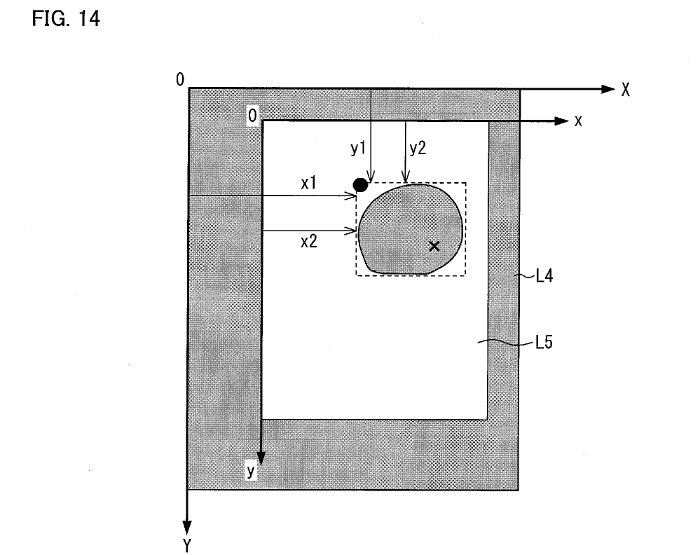

The following description discusses, with reference to FIG. 14, how to specify, in accordance with reference coordinates, a touch position in the superimposed layer. FIG. 14 illustrates how to specify, in accordance with the reference coordinates, the touch position in the superimposed layer. In FIG. 14, the superimposed layer is indicated by L4 and the background layer is indicated by L5.

The superimposed layer L4, in which a web page of the background layer L5 is enlarged and displayed, is larger than the background layer L5. However, an image of the superimposed layer L4 which image is to be displayed is only an image of a part of the superimposed layer L4 which part is located in the background layer L5 and corresponds to the pixels having the superimposed attribute in the map 32. That is, only the part of the image of the superimposed layer L4 which part corresponds to the pixels having the superimposed attribute is displayed as the superimposed object.

In FIG. 14, a rectangular region including the superimposed object is shown by a broken line. Coordinates of an upper left corner of the rectangular region serve as the reference coordinates. That is, the reference coordinates can be found by specifying the rectangular region in accordance with contour data on the superimposed object. The reference coordinates are expressed as (x1,y1) in the superimposed layer L4 assuming that an origin at an upper left corner of the superimposed layer L4 is a reference. The reference coordinates are expressed as (x2,y2) in the background layer L5 assuming that an origin at an upper left corner of the background layer L5 is a reference.

Assume here that a touch operation has been carried out with respect to a point x on the superimposed object. In a case where the touch operation has been carried out at a position whose coordinates (assuming that the origin at the upper left corner of the background layer L5 is the reference) are expressed as (x,y), coordinates of the touch position in the superimposed layer are expressed as (x1−x2+x,y1−y2+y). Use of this coordinate value makes it possible to specify what operation has been carried out with respect to the superimposed layer (e.g., which link has been selected).

[Object Display Process]

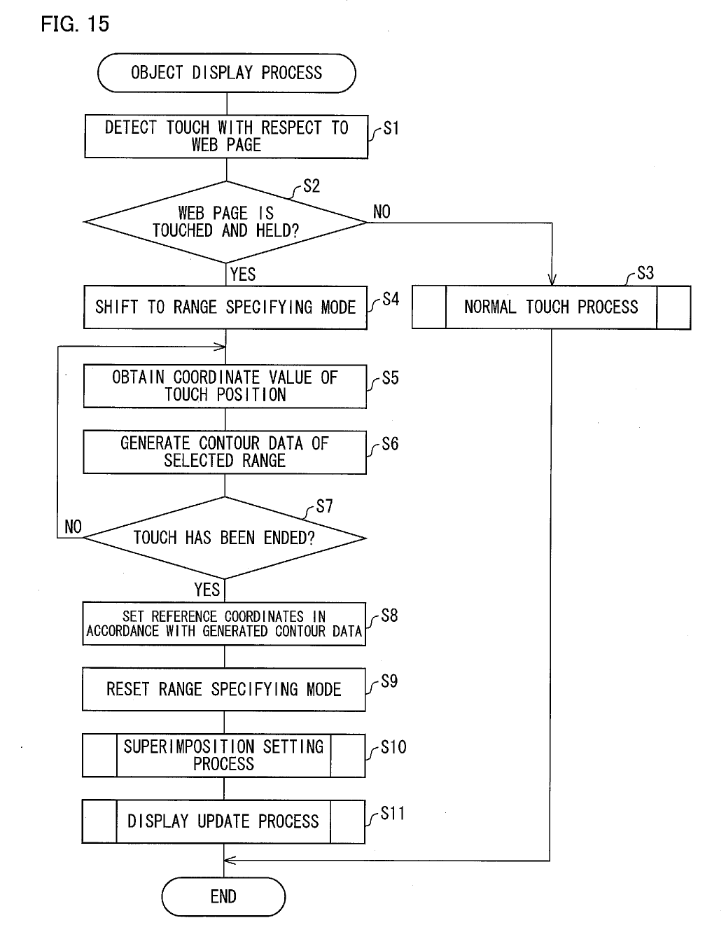

The following description discusses, with reference to FIG. 15, how to carry out an object display process (a display control method), which is a process for displaying the superimposed object. FIG. 15 is a flow chart showing an example of the object display process.

First, the operation determination section 10 detects, in accordance with information notified by the input section 400, that a touch operation has been carried out with respect to a web page which is being displayed (S1). Then, the operation determination section 10 determines whether or not the touch operation is a touch-and-hold operation (an identical position is being touched for not less than a predetermined time period) (S2).

The operation determination section 10 which determines that the touch operation is not the touch-and-hold operation (NO at S2) determines that a normal touch operation has been carried out, and notifies the touch processing section 13 of coordinates of the touch position so as to cause the touch processing section 13 to carry out a normal touch process (S3). According to the normal touch process, the touch processing section 13 carries out a process in accordance with the touched position. For example, in a case where a link is displayed at the touch position, the touch processing section 13 carries out a process for displaying content at a link destination. In a case where a button is displayed at the touch position, the touch processing section 13 carries out a process in accordance with the button. In a case where the normal touch process is carried out, the information processing device 1 ends the object display process.

Meanwhile, the operation determination section 10 which determines that the touch operation is the touch-and-hold operation (YES at S2) gives the superimposed display processing section 12 a notification of the determination. The superimposed display processing section 12 which has received the notification shifts to a range specifying mode (S4). The superimposed display processing section 12 which has shifted to the range specifying mode displays a cursor prestored for the range specifying mode, instead of a cursor which had been displayed before the superimposed display processing section 12 shifted to the range specifying mode. The superimposed display processing section 12 obtains, via the operation determination section 10, a coordinate value of the touch position which is received by the input section 400 (S5, a receiving step). Subsequently, the superimposed display processing section 12 generates, from the obtained coordinate value, contour data indicative of a contour of a selected range (a trajectory of the touch position in the operation range specifying mode) (S6), and then determines whether or not the touch operation has been ended (S7).

In a case where the superimposed display processing section 12 determines that the touch operation has not been ended (NO at S7), the process returns to S5. Meanwhile, the superimposed display processing section 12 which determines that the touch operation has been ended (YES at S7) sets reference coordinates in accordance with the generated contour data (S8). Then, the superimposed display processing section 12 resets the range specifying mode (S9) and carries out a superimposition setting process (S10, a superimposed display step). Thereafter, the display control section 18 carries out a display update process (S11), so that the superimposed object is displayed. With this, the object display process is ended.

[Superimposition Setting Process]

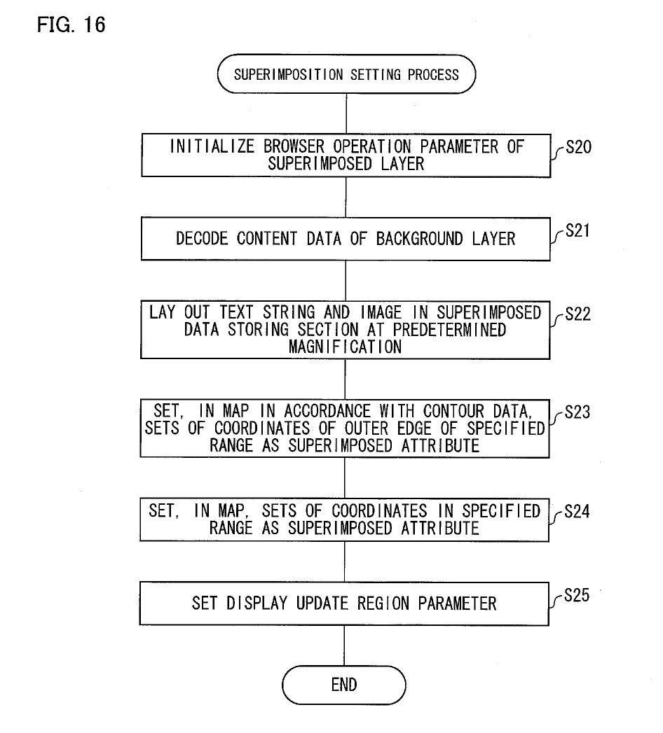

The following description specifically discusses, with reference to FIG. 16, the superimposition setting process carried out at S10 of FIG. 15. FIG. 16 is a flow chart showing an example of the superimposition setting process. The superimposition setting process is a process for displaying the superimposed object so that the superimposed object is superimposed on the web page.

First, the superimposed display processing section initializes a browser operation parameter of the superimposed layer in the superimposed layer management table 31 (S20). Further, the superimposed display processing section 12 decodes (or analyzes) content data (data constituting a web page to be displayed in the background layer; e.g., an HTML file and image data) of the background layer (S21). Then, the superimposed display processing section 12 (i) enlarges, at a predetermined magnification, a text string and an image each obtained by the decoding and (ii) lays out the text string and the image in the superimposed data storing section 34 (S22). Note that the magnification can be 1× in a case where the text string and the image do not need to be enlarged.

Subsequently, the superimposed display processing section 12 sets, in the map 32 in accordance with the contour data generated at S6 of FIG. 15, sets of coordinates of an outer edge of a specified range (sets of coordinates which sets constitute a trajectory of an operation to specify a range) as the superimposed attribute (S23). The superimposed display processing section 12 sets, in the map 32, sets of coordinates in the specified range (a region surrounded by the trajectory of the operation to specify the range) as the superimposed attribute (S24). Then, the superimposed display processing section 12 sets a display update region parameter indicative of a region in which a display is to be updated (e.g., a parameter indicative of (i) reference coordinates and (ii) a width and a height of a rectangular region including the contour data) (S25), and stores the display update region parameter in the superimposed layer management table 31. Further, the superimposed display processing section 12 notifies the display control section 18 that the display update region parameter has been updated. With this, the superimposition setting process is ended.

[Display Update Process]

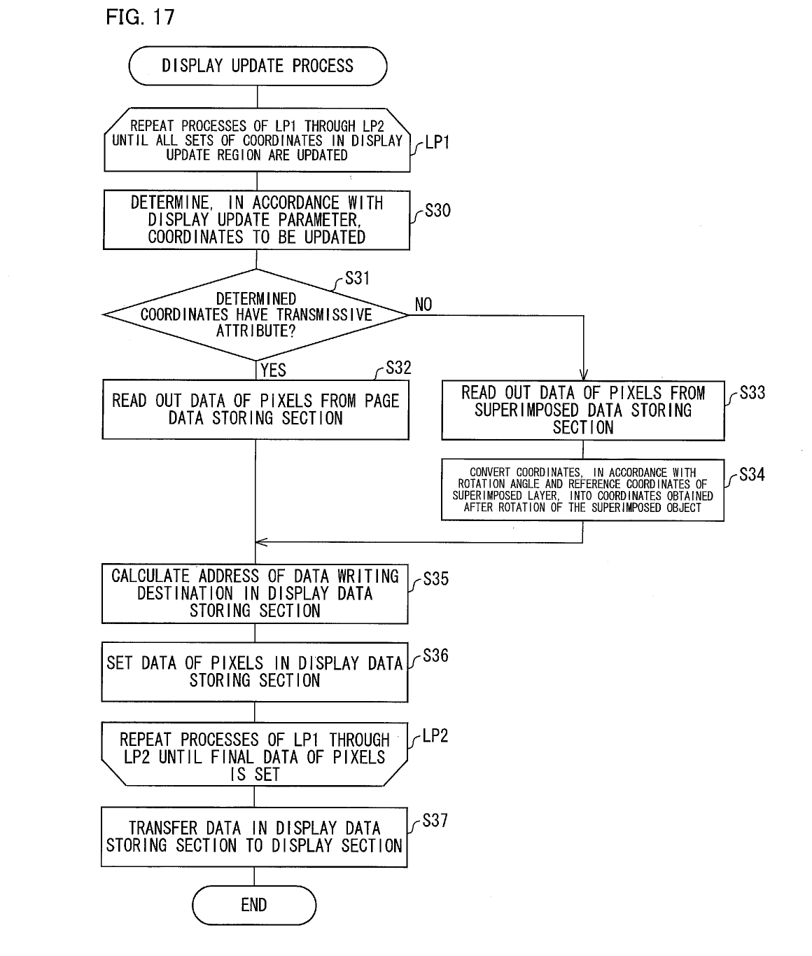

The following description specifically discusses, with reference to FIG. 17, the display update process carried out at S11 shown in FIG. 15. FIG. 17 is a flow chart showing an example of the display update process. The display control section 18 which is notified that the display update region parameter has been updated carries out processes of LP1 through LP2 with respect to all sets of coordinates in a display update region. First, the display control section 18 determines, in accordance with the display update parameter, coordinates to be updated (S30). Specifically, the display control section 18 determines a set of coordinates from the sets of coordinates in the region indicated by the display update parameter. Subsequently, the display control section 18 determines, with reference to the map 32, whether or not the determined set of coordinates has the “transmissive” attribute (S31).

The display control section 18 which determines that the determined set of coordinates has the “transmissive” attribute (YES at S31) reads out, from the page data storing section 33, data of pixels corresponding to the set of coordinates which set was determined at S30 (S32), and then the process proceeds to S35. Meanwhile, the display control section 18 which determines that the determined set of coordinates has no “transmissive” attribute (has the “superimposed” attribute) (NO at S31) reads out, from the superimposed data storing section 34, the data of the pixels corresponding to the set of coordinates which set was determined at S30 (S33). Further, the display control section 18 converts that set of coordinates, in accordance with a rotation angle and reference coordinates of the superimposed layer, into coordinates obtained after rotation of the superimposed object (S34), and then the process proceeds to S35. It is needless say that the process of S34 can be omitted in a case where the superimposed object is not rotated (the rotation angle is zero).

At S35, the display control section 18 calculates an address of a data writing destination in the display data storing section 35, the address corresponding to the set of coordinates (the set of coordinates which set was determined at S30 or the coordinates obtained after the conversion at S34). Then, the display control section 18 sets, in the display data storing section 35, the data of the pixels which data was read out at S32 or S33 (S36). The display control section 18 which has finished carrying out the processes of S30 through S36 (described above) with respect to all the sets of coordinates in the region indicated by the display update parameter transfers the data in the display data storing section 35 to the display section 300 (S37). With this, an image displayed in the display section 300 is updated, and the display update process is ended.

[Touch Operation Handling Process]

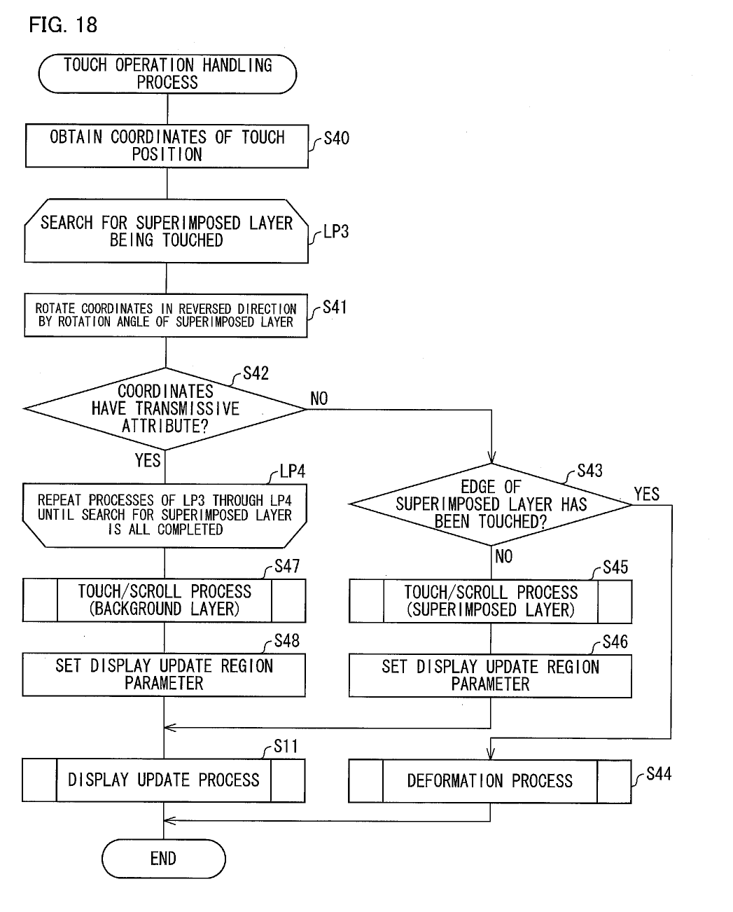

The following description discusses, with reference to FIG. 18, a touch operation handling process to be carried out when a touch operation is carried out. FIG. 18 is a flow chart showing an example of the touch operation handling process. Note that the touch operation refers to an operation carried out by touching a display surface with one finger.

First, the operation determination section 10 which detects, in accordance with the information notified by the input section 400, that a touch operation has been carried out with respect to a web page which is being displayed obtains coordinates of a touch position (S40). Thereafter, the operation determination section 10 (i) searches, with reference to the map 32, for a superimposed layer being touched, and (ii) repeats the processes of LP3 through LP4 until completion of the search for the superimposed layer.

In the processes of LP3 through LP4, the operation determination section 10 reads out first, from the superimposed layer management table 31, a rotation angle and reference coordinates of the detected superimposed layer, and then carries out coordinate conversion in which the coordinates obtained at S40 rotates about the reference coordinates in a reversed direction by the rotation angle (S41). Note that, in a case where the detected superimposed layer has not been rotated, the operation determination section 10 carries out the process of S41 assuming that the rotation angle is 0. In this case, where the coordinates are unchanged at S41, such an arrangement makes it possible to standardize procedures for the process irrespective of whether or not the superimposed layer has been rotated.

Subsequently, the operation determination section 10 determines, with reference to the map 32, whether or not the coordinates obtained by carrying out the conversion at S41 have the transmissive attribute (S42). The operation determination section 10 which determines that the coordinates have no transmissive attribute (have the superimposed attribute) (NO at S42) determines whether or not an edge (an outer edge) of the superimposed layer has been touched (S43). Specifically, in a case where the coordinates obtained at S40 are located in (i) a first pixel (an outermost pixel) defining a contour of the superimposed layer or (ii) a second pixel of the superimposed layer which second pixel is located within a predetermined range of the pixel, the operation determination section 10 which refers to the map 32 determines that the edge has been touched.

The operation determination section 10 which determines that the edge has been touched (YES at S43) determines that an operation to carry out a deformation process has been carried out, and gives the deformation section 15 a notification of the determination. The deformation section 15 which has received the notification carries out the deformation process so as to deform the superimposed object (S44). With this, the touch operation handling process is ended.

Meanwhile, in a case where the operation determination section 10 determines that no edge has been touched (a region inside of the outer edge of the superimposed layer has been touched) (NO at S43), the touch process or the scroll process is carried out with respect to the superimposed layer (S45). Specifically, in a case where the touch position is unchanged and the touch is ended within a predetermined time period, the operation determination section 10 notifies the touch processing section 13 of (i) coordinates of the touch position and (ii) the superimposed layer which has been subjected to the touch operation, and causes the touch processing section 13 to carry out the touch process. According to the touch process, in a case where there is a link at the touch position, the touch processing section 13 downloads content at a link destination and decodes the downloaded content. Then, the touch processing section 13 lays out, in the superimposed data storing section 34, a text string and an image which are contained in data of the content at a predetermined magnification. In a case where the touch position is changed within the predetermined time period, the operation determination section 10 notifies the scroll processing section 14 of (i) the touch position which has not been changed and the touch position which has been changed and (ii) the superimposed layer which has been subjected to the touch operation, and causes the scroll processing section 14 to carry out the scroll process. According to the scroll process, the scroll processing section 14 changes, in accordance with a change in coordinate value of the touch position, data to be stored in the superimposed data storing section 34. The touch processing section 13 or the scroll processing section 14 sets a display update region parameter indicative of a region including the superimposed layer which has been subjected to the touch operation (S46), and then notifies the display control section 18 that the display update region parameter has been updated. Thereafter, the display control section 18 carries out the display update process (described earlier) (S11). With this, the image displayed in the display section 300 is updated, and the touch operation handling process is ended.

In a case where the search for the superimposed layer has been all completed when the operation determination section 10 determines at S42 that the coordinates have the transmissive attribute (YES at S42), the touch process or the scroll process is carried out with respect to the background layer (S47). Note that, since the touch process and the scroll process which are carried out with respect to the background layer are different in layer to be processed but similar to those carried out at S45, a specific description thereof is omitted here. The touch processing section 13 or the scroll processing section 14 sets a display update region parameter indicative of a region of the background layer (S48), and then notifies the display control section 18 of the display update region parameter. Thereafter, the display control section 18 carries out the display update process (S11). With this, the image displayed in the display section 300 is updated, and the touch operation handling process is ended.

[Deformation Process]

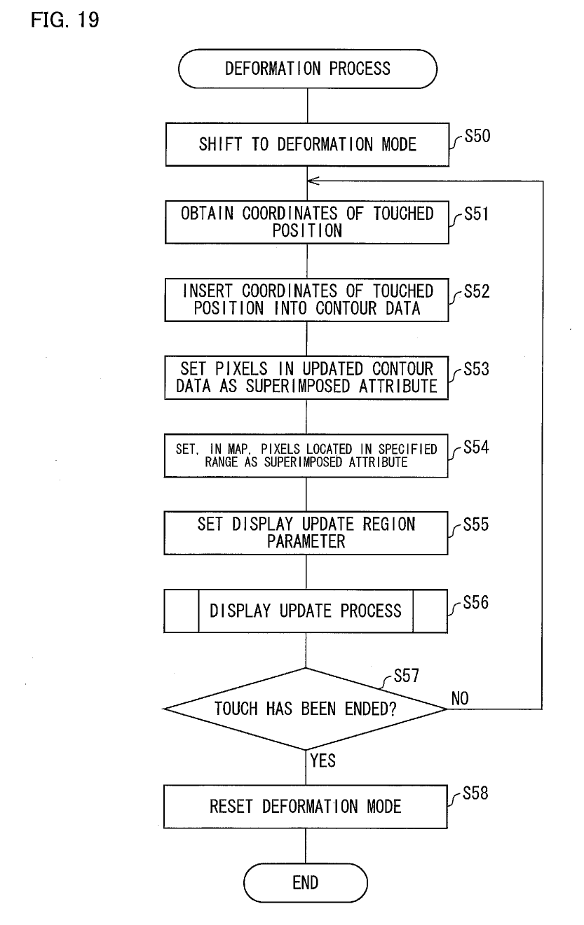

The following description discusses, with reference to FIG. 19, the deformation process carried out at S44 shown in FIG. 18. FIG. 19 is a flow chart showing an example of the deformation process. First, the deformation section 15 shifts to a deformation mode (S50), and displays a cursor prestored for the deformation mode, instead of the cursor which had been displayed before the deformation section shifted to the deformation mode. Subsequently, the deformation section 15 obtains coordinates of a current touch position via the operation determination section 10 (S51), and then inserts the coordinates into the contour data (adds the coordinates as one of sets of coordinates constituting the contour data) (S52).

Subsequently, the deformation section 15 sets, in the map 32, pixels in the updated contour data as the superimposed attribute (S53). The deformation section 15 also sets pixels located in the specified range surrounded by the contour data as the superimposed attribute (S54). Subsequently, the deformation section 15 sets a display update region parameter indicative of a region including the updated contour data (S55). Then, the deformation section 15 notifies the display control section 18 of the display update region parameter, and causes the display control section 18 to carry out the display update process (described earlier) (S56).

In a case where the touch operation is being continued (NO at S57), the deformation section 15 carries out the process of S51 again. Meanwhile, in a case where the touch operation has been ended (YES at S57), the deformation section 15 resets the deformation mode and replaces the cursor with the previously displayed cursor. With this, the deformation process is ended.

[Two-Finger Touch Operation Handling Process]

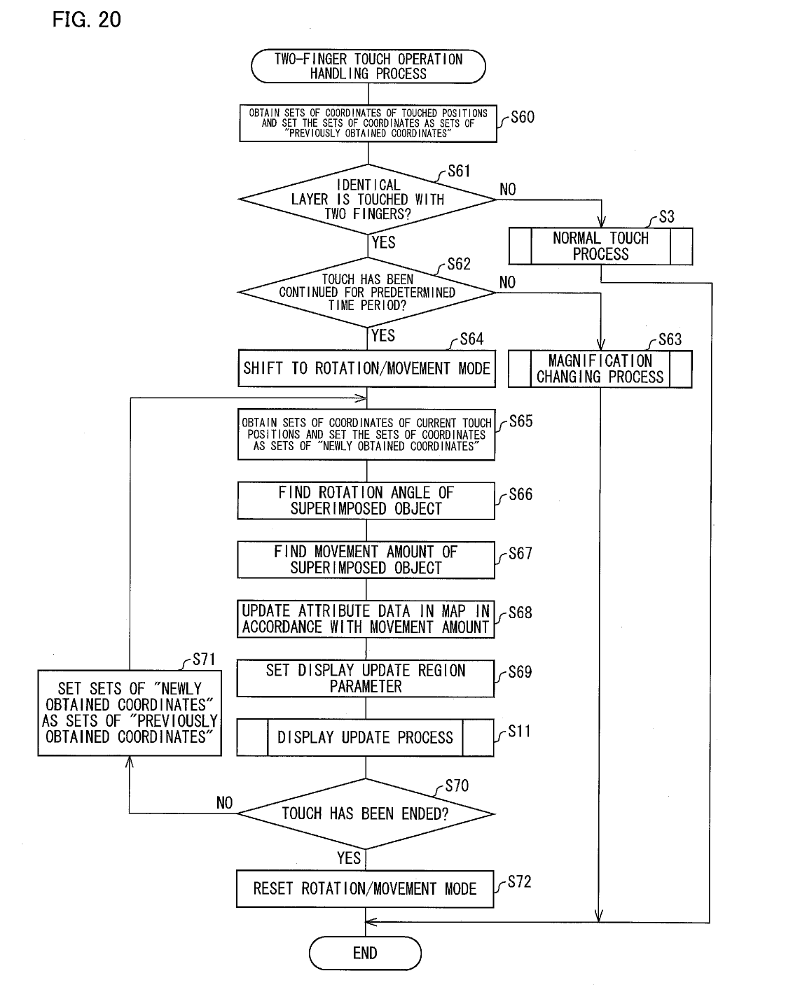

The following description discusses a two-finger touch operation handling process with reference to FIG. 20. FIG. 20 is a flow chart showing an example of the two-finger touch operation handling process. Note that the two-finger touch operation refers to an operation carried out by simultaneously touching a display surface with two fingers. As described earlier, the touch process or the scroll process is carried out by the touch operation with one finger. Meanwhile, movement or rotation of an object is carried out by the two-finger touch operation. Thus, according to the information processing device 1, different processes are carried out depending on the number of fingers for use in the operation.

First, the operation determination section 10 obtains, from the information notified by the input section 400, respective sets of coordinates of two points which have been touched, and then sets these sets of coordinates as sets of “previously obtained coordinates” (S60). Next, the operation determination section 10 determines, with reference to the map 32, whether an identical layer is touched with two fingers (S61).

The operation determination section 10 which determines that no identical layer is touched with the two fingers (NO at S61) determines that the normal touch operation has been carried out, and notifies the touch processing section 13 of sets of coordinates of touch positions so as to cause the touch processing section 13 to carry out the normal touch process (described earlier) (S3). With this, the two-finger touch operation handling process is ended.

Meanwhile, the operation determination section 10 which determines that the identical layer is touched with the two fingers (YES at S61) determines whether or not the touch has been continued for a predetermined time period (S62). In a case where the touch is released before the predetermined time period passes (NO at S62), the operation determination section 10 notifies the magnification changing section 17 of (i) the sets of coordinates of the touch positions which have been touched until the touch is released and (ii) the layer which has been subjected to the touch operation, and causes the magnification changing section 17 to carry out a magnification changing process (S63). According to the magnification changing process, in order that a display is carried out at a display magnification in accordance with the notified sets of coordinates, the magnification changing section 17 updates data of the layer which has been subjected to the touch operation (data to be stored in the page data storing section 33 or the superimposed data storing section 34). Specifically, in a case where a so-called pinch-in operation is carried out, the magnification changing section 17 updates the data so that a display image is reduced. Meanwhile, in a case where a pinch-out operation is carried out, the magnification changing section 17 updates the data so that the display image is enlarged. The magnification changing section 17 sets a display update region parameter indicative of a region in which the data has been updated and notifies the display control section 18 that the display update region parameter has been set. Thereafter, the display control section 18 carries out the display update process (described earlier). With this, the image displayed in the display section 300 is updated, and the two-finger touch operation handling process is ended.

Meanwhile, the operation determination section 10 which determines at S62 that the touch has been continued for the predetermined time period (YES at S62) gives the movement processing section 16 a notification of (i) the determination and (ii) the coordinates set at S60. The movement processing section 16 which has received the notification shifts to a rotation/movement mode (S64). The movement processing section 16 which has shifted to the rotation/movement mode displays a cursor prestored for the rotation/movement mode, instead of the cursor which had been displayed before the movement processing section 16 shifted to the rotation/movement mode.

Subsequently, the movement processing section 16 obtains sets of coordinates of current touch positions via the operation determination section 10, and then sets these sets of coordinates as sets of “newly obtained coordinates” (S65). Next, the movement processing section 16 finds, in accordance with (i) the sets of “previously obtained coordinates” notified by the operation determination section 10 and (ii) the sets of “newly obtained coordinates,” an angle at which to rotate the superimposed object (S66). Specifically, in a case where the sets of “previously obtained coordinates” and the sets of “newly obtained coordinates” include identical coordinates (sets of coordinates between which sets there exists a difference in value, the difference falling within a predetermined range can be considered as identical coordinates), the movement processing section 16 defines the identical coordinates as central coordinates. Then, the movement processing section 16 finds an angle formed by (i) a segment connecting the central coordinates and other coordinates of the sets of “previously obtained coordinates” and (ii) a segment connecting the central coordinates and other coordinates of the sets of “newly obtained coordinates.” Meanwhile, in a case where there exists no central coordinates, the movement processing section 16 finds a movement amount of the superimposed object in accordance with the sets of “previously obtained coordinates” and the sets of “newly obtained coordinates” (S67). Specifically, the movement processing section 16 calculates (i) coordinates of a midpoint between two sets of “previously obtained coordinates” and (ii) coordinates of a midpoint between two sets of “newly obtained coordinates,” and then calculates a distance between the coordinates (i) and the coordinates (ii). Then, the movement processing section 16 calculates a movement amount in accordance with the calculated distance and specifies a movement direction in accordance with a positional relationship between the coordinates (i) and the coordinates (ii). For example, the movement processing section 16 may specify the movement amount and the movement direction by each of which the superimposed object can move so as to follow the touch position.

Subsequently, the movement processing section 16 updates attribute data in the map 32 in accordance with the calculated movement amount (S68). Specifically, the movement processing section 16 moves, by the movement amount in the movement direction, each of pixels (i) corresponding to the superimposed layer which has been subjected to the touch operation and (ii) having the superimposed attribute. The movement processing section 16 sets a display update region parameter specifying a region including the superimposed layer which has not been moved and a region including the superimposed layer which has been moved (S69). Then, the movement processing section 16 notifies the display control section 18 of the setting of the display update region parameter, and causes the display control section 18 to carry out the display update process (described earlier) (S11).

In a case where the touch operation is being continued (NO at S70), the movement processing section 16 sets, as the sets of “previously obtained coordinates”, the sets of coordinates which sets were obtained at S65 and have been set as the sets of “newly obtained coordinates” before S71 (S71), and then carries out the process of S65 again. Meanwhile, in a case where the touch operation has been ended (YES at S70), the movement processing section 16 resets the rotation/movement mode and replaces the cursor with the previously displayed cursor. With this, the two-finger touch operation handling process is ended. The two-finger touch operation handling process allows a user to, while sliding two fingers with which the display surface is being touched, simultaneously move and rotate the superimposed object by drawing an ark with one of the two fingers by using the other one of the two fingers as a fulcrum. This makes it possible for the user to promptly and smoothly carry out, through an intuitive operation, an input for displaying the superimposed object at a desired position in a desired direction.

[Screen Capture Process]

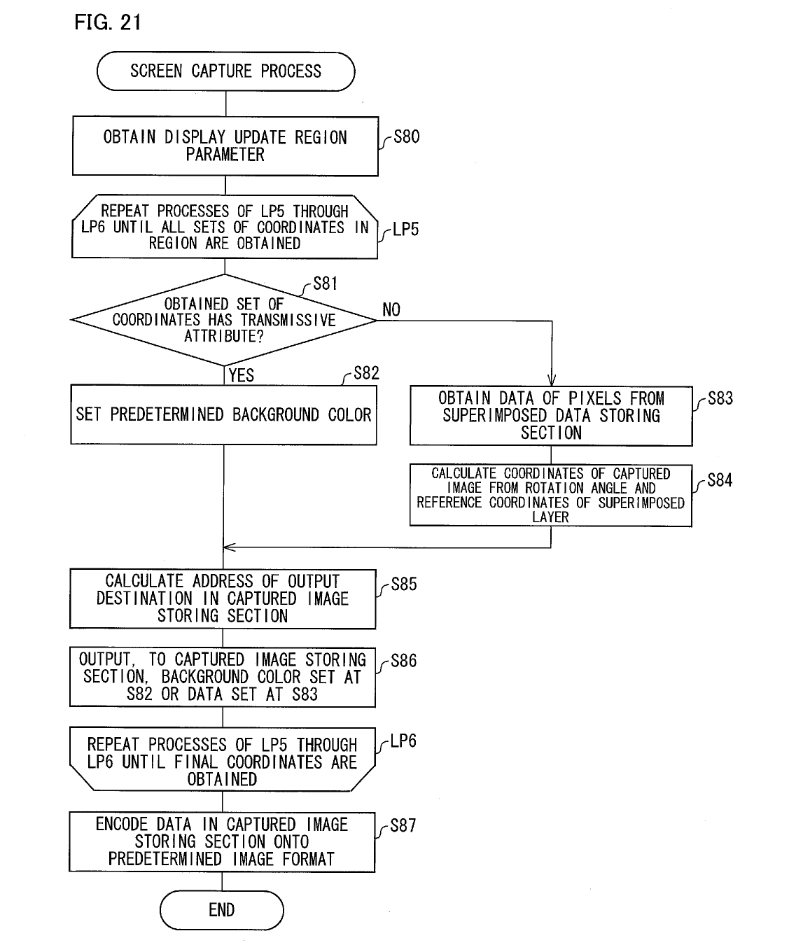

The following description discusses, with reference to FIG. 21, a screen capture process carried out when the screen capture is selected from the menu. FIG. 21 is a flow chart showing an example of the screen capture process.

The operation determination section 10 which determines, from the information notified by the input section 400, that the screen capture has been selected from the menu stores, in the superimposed layer management table 31, a display update region parameter indicative of a rectangular region including a superimposed layer to be screen-captured. Then, the operation determination section 10 gives the capture section 21 a notification of the storage of the display update region parameter in the superimposed layer management table 31. The capture section 21 which has received the notification obtains, from the superimposed layer management table 31, the notified display update region parameter of the superimposed layer (S80). The operation determination section 10 determines data of each pixel in the rectangular region by carrying out the processes of LP5 through LP6 with respect to all sets of coordinates in the region indicated by that display update region parameter.

In the processes of LP5 through LP6, the capture section 21 obtains a set of coordinates from the region and then determines, with reference to the map 32, whether or not that set of coordinates has the transmissive attribute (S81). In a case where the set of coordinates has the transmissive attribute (YES at S81), the capture section 21 determines that a predetermined background color is to be displayed at a position of the set of coordinates (S82). Then, the process proceeds to S85. With this, the predetermined background color is displayed in a part other than the superimposed layer (pixels corresponding to the background layer) of a captured image.

Meanwhile, the capture section 21 which determines that the set of coordinates has no transmissive attribute (NO at S81) obtains, from the superimposed data storing section 34, data of pixels corresponding to the set of coordinates (S83). Further, the capture section 21 calculates, from a rotation angle and reference coordinates each read out from the superimposed layer management table 31, coordinates of the captured image which correspond to the obtained set of coordinates (S84). Specifically, the capture section 21 calculates coordinates of a position of the obtained set of coordinates rotated about the reference coordinates by the rotation angle. It is needless say that the process of S84 can be omitted in a case where the superimposed object is not rotated (the rotation angle is zero).

Subsequently, the capture section 21 calculates an address of an output destination in the captured image storing section 37 to which output destination to output the background color set at S82 or the data obtained at S83 (S85). In a case where the background color has been set at S82, the address of the output destination is an address in accordance with a value of the obtained coordinates. In a case where the data has been obtained from the superimposed data storing section 34, the address of the output destination is an address in accordance with a value of the coordinates calculated at S84. Then, the capture section 21 transmits, to the address calculated at S85, the background color set at S82 or the data obtained at S83 (S86).

When the processes of LP5 through LP6 with respect to all the sets of coordinates in the region are ended, the capture section 21 generates image data by encoding data in the captured image storing section 37 onto a predetermined image format (e.g., BMP, JPEG, PNG, etc.) (S87). With this, the screen capture process is ended. Note that, the image data, which is not shown in FIG. 21, is preferably transmitted to, for example, a shared memory such as a clipboard so as to be also usable in another application.

[Bookmark Process]

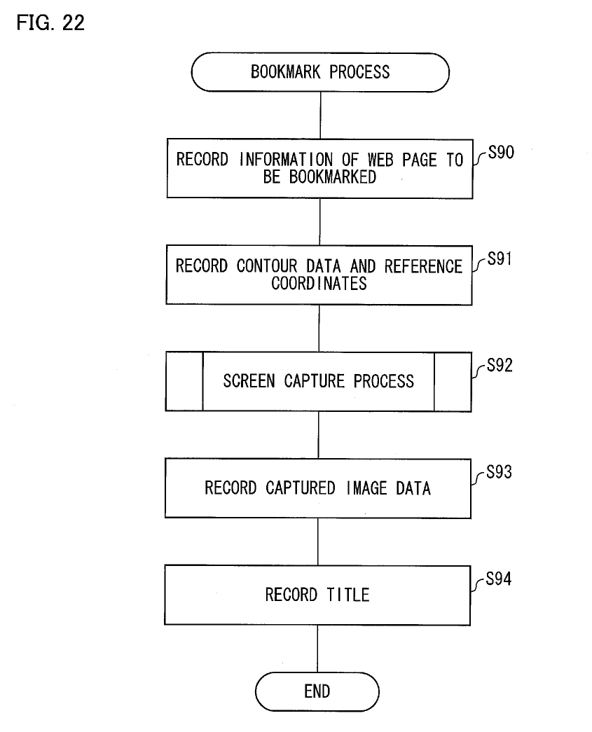

The following description discusses, with reference to FIG. 22, a bookmark process carried out when the bookmark is selected from the menu. FIG. 22 is a flow chart showing an example of the bookmark process.

The operation determination section 10 which determines, from the information notified by the input section 400, that the bookmark in the menu has been selected gives the bookmark control section 22 a notification of a superimposed layer to be bookmarked. The bookmark control section 22 which has received the notification records, in the bookmark table 38, information (e.g., an URL) of an original web page on which the superimposed layer to be bookmarked is based (S90). The bookmark control section 22 which refers to the superimposed layer management table 31 reads out contour data and reference coordinates of the superimposed layer to be bookmarked, and then records, in the bookmark table 38, the contour data and the reference coordinates (S91).

Further, the bookmark control section 22 notifies a capture processing section of the superimposed layer to be bookmarked, and causes the capture processing section to carry out the screen capture process (described earlier) (S92). Then, the bookmark control section 22 saves, in the bookmark table 38, image data generated by the screen capture process (S93). The bookmark control section 22 also saves, in the bookmark table 38, a title which is set by a user (S94). With this, the bookmark process is ended.

[Bookmark Display Process]

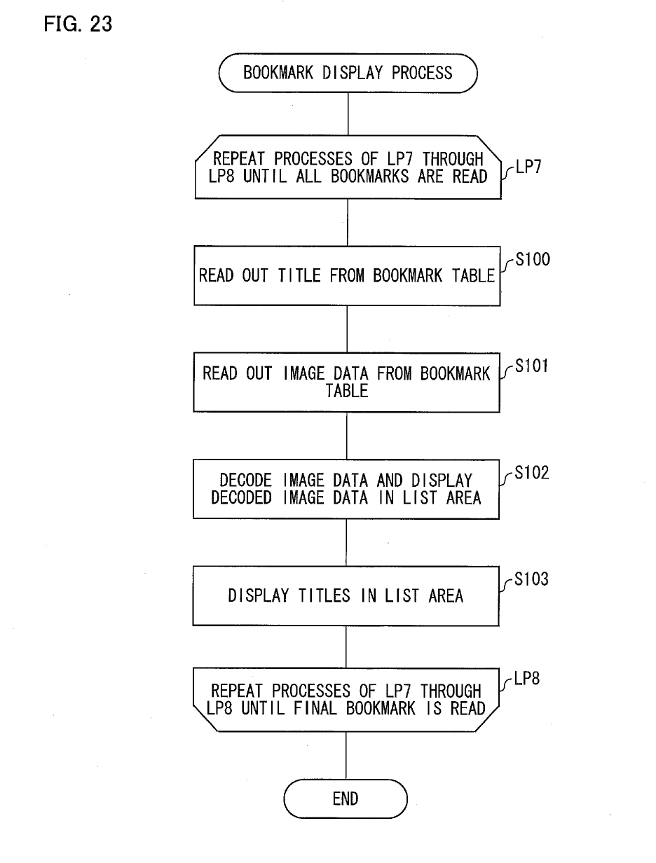

The following description discusses, with reference to FIG. 23, a bookmark display process carried out when an operation to display bookmarks in a list is carried out. FIG. 23 is a flow chart showing an example of the bookmark display process.

The operation determination section 10 which determines, from the information notified by the input section 400, that the operation to display the bookmarks in a list has been carried out gives the bookmark control section 22 a notification of the determination. The bookmark control section 22 which has received the notification repeats processes of LP7 through LP8, i.e., processes for reading out data on one (1) bookmark from the bookmark table 38, until the bookmark control section 22 finishes reading out data on all the bookmarks.

In the processes of LP7 through LP8, the bookmark control section 22 reads out a title and image data (a captured image) from the bookmark table 38 (S100, S101). Then, the bookmark control section 22 decodes the read image data and then causes the display section 300 to display the image data (S102). The bookmark control section 22 also causes the display section 300 to display the read title (S103). In a case where these processes are carried out with respect to all the bookmarks, the image data (the captured image) and the titles of each of the bookmarks are displayed in a list so as to be associated with each other.

[Bookmark Page Display Process]

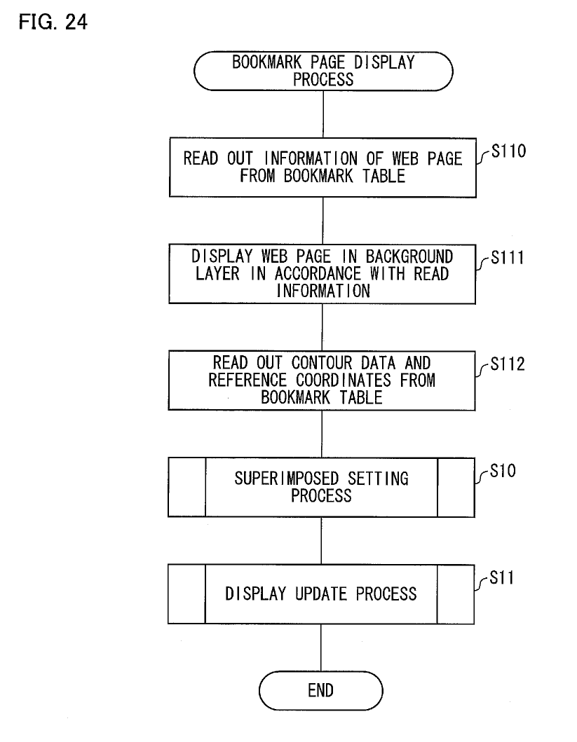

The following description discusses, with reference to FIG. 24, a bookmark page display process carried out when a bookmark is selected from the bookmarks thus displayed in a list as described earlier. FIG. 24 is a flow chart showing an example of the bookmark page display process.

The operation determination section 10 which determines, from the information notified by the input section 400, that the operation to select a bookmark has been carried out notifies the bookmark control section 22 of the selected bookmark. The bookmark control section 22 which has been notified of the selected bookmark reads out, from the bookmark table 38, information of a web page of the selected bookmark (S110).

Next, the bookmark control section 22 displays the web page in the background layer in accordance with the read information (5111). That is, the bookmark control section 22 displays, in the background layer, the web page on which the superimposed object thus bookmarked is based.

Subsequently, the bookmark control section 22 reads out contour data and reference coordinates from the bookmark table 38 (S112), and then notifies the superimposed display processing section 12 of the contour data and the reference coordinates so as to cause the superimposed display processing section 12 to carry out the superimposition setting process (S10). Thereafter, the display control section 18 carries out the display update process (S11). With this, the superimposed object is displayed so as to be superimposed on the web page displayed at 5111, and the bookmark page display process is ended.

[Copy Process]

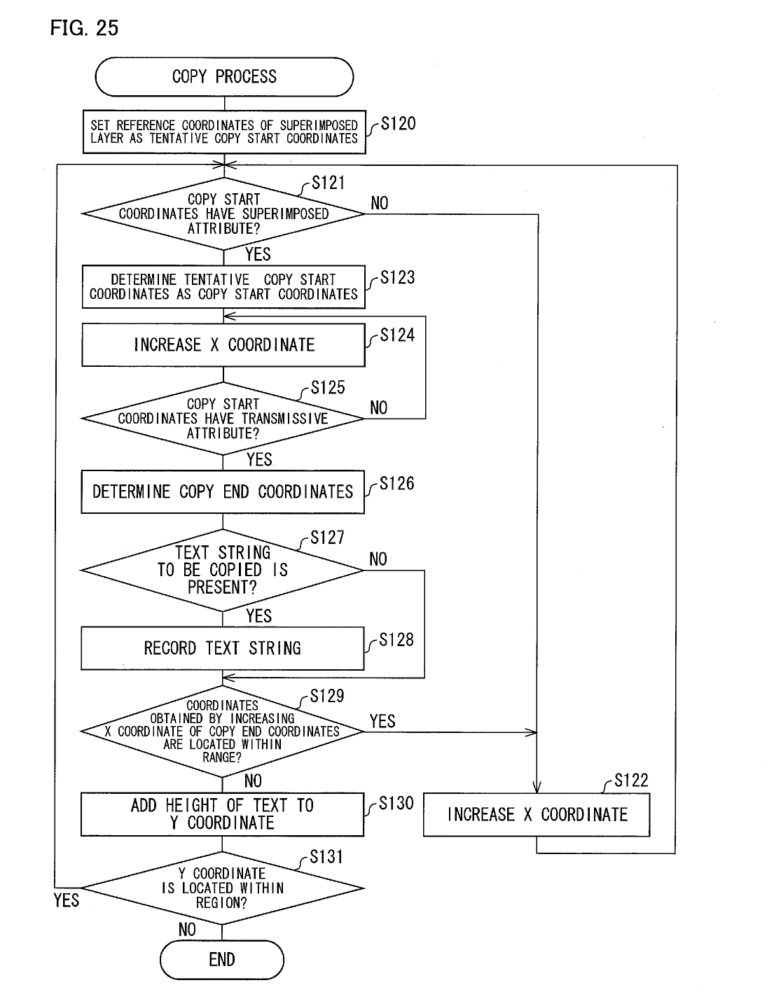

The following description discusses, with reference to FIG. 25, a copy process carried out when the copy is selected from the menu. FIG. 25 is a flow chart showing an example of the copy process. The operation determination section 10 which determines, from the information notified by the input section 400, that the copy has been selected from the menu notifies the copy section 20 of a superimposed layer to be copied. The copy section 20 which has been notified of the superimposed layer to be copied reads out, from the superimposed layer management table 31, reference coordinates of the notified superimposed layer and sets the reference coordinates as tentative copy start coordinates (S120).

Next, the copy section 20 determines, with reference to the map 32, whether or not the tentative copy start coordinates have the superimposed attribute (S121). The copy section 20 which determines that the tentative copy start coordinates have no superimposed attribute (NO at S121) increases, by one, an x coordinate of the tentative copy start coordinates (S122). Then, the copy section 20 determines whether or not the tentative copy start coordinates having the increased x coordinate have the superimposed attribute (S121). The copy section 20 which determines at S121 that the tentative copy start coordinates having the increased x coordinate have the superimposed attribute (YES at S121) determines that the tentative copy start coordinates are copy start coordinates (S123).

Subsequently, the copy section 20 increases, by one, an x coordinate of the copy start coordinates determined at S123 (S124). Then, the copy section 20 determines whether or not the copy start coordinates having the increased x coordinate have the transmissive attribute (S125). The copy section 20 which determines that the copy start coordinates having the increased x coordinate have no transmissive attribute (NO at S125) carries out the process of S124 again so as to further increase, by one, the x coordinate of the copy start coordinates. The copy section which determines at S125 that the copy start coordinates having the increased x coordinate have the transmissive attribute (YES at S125) determines that coordinates obtained by reducing, by one, the x coordinate of the copy start coordinates are copy end coordinates (S126). For example, in a case where the reference coordinates are (x0,y0), the copy section 20 determines at S123 that the copy start coordinates are (x1,y0). The copy section 20 which determines at S125 that coordinates (x2,y0) have the transmissive attribute determines that coordinates (x2-1,y0) is the copy end coordinates. With this, a range of the coordinates (x1,y0) to the coordinates (x2-1,y0) is to be copied.

Next, the copy section 20 determines whether or not a text string to be copied is present in the range of the copy start coordinates to the copy end coordinates (S127). Whether or not the text string is present in the range can be determined with reference to, for example, an HTML file of a web page displayed in the superimposed layer. The copy section 20 which determines that the text string is present in the range (YES at S127) records the text string in the copy text storing section 36 (S128) and then carries out the process of S129. Meanwhile, the copy section 20 which determines that no text string is present in the range (NO at S127) skips the process of S128 and carries out the process of S129.

At S129, the copy section 20 determines whether or not coordinates obtained by increasing, by one, an x coordinate of the copy end coordinates are located within a range indicated by the display update range setting parameter. The copy section 20 which determines that the coordinates are located within the region (YES at S129) further increases, by one, the x coordinate of the coordinates (S122) and carries out the process of S121 again. Meanwhile, the copy section 20 which determines that the coordinates are located beyond the region (NO at S129) adds a height of the text to a y coordinate of the coordinates (S130) and determines whether or not the y coordinate to which the height of the text has been added is located within the region indicated by the display update range setting parameter. Note that the height of the text can be specified in accordance with the browser operation parameter in the superimposed layer management table 31. The copy section 20 which determines that the y coordinate is located within the region (YES at S130) carries out the process of S121 again. Meanwhile, the copy section 20 which determines that the y coordinate is located beyond the region (NO at S130) ends the copy process.

### Embodiment 2

According to the information processing device 1, how to specify the input operation is not limited to the example described earlier, but may be determined in accordance with, for example, specifications of the device. For example, according to the example described earlier, the superimposed object is moved or rotated with two fingers. Alternatively, the superimposed object can be moved or rotated with one finger.

In this case, for example, when the superimposed object is subjected to a touch-and-hold operation (an operation to continue touching, for not less than a predetermined time period, a position in a range in which the superimposed object is being displayed), a touch/scroll mode can be switched to a movement mode. Note that the touch/scroll mode is a mode in which to receive (i) a touch operation with one finger and (ii) a scrolling operation. In the movement mode, the superimposed object which is dragged can be moved. Further, in the movement mode, the superimposed object on which a user makes a gesture to draw an ark can be rotated by an angle in accordance with a length of the ark in a direction in which the ark has been drawn.

For example, when a predetermined gesture (e.g., a gesture to draw a small circle) is made on the superimposed object, a “pinch” can be displayed at a position at which the gesture is made. Then, the superimposed object which is subjected to the dragging operation while the pinch is being touched can be moved. When a gesture to draw an ark is made around the pinch, the superimposed object can be rotated by an angle in accordance with a length of the ark in a direction in which the ark has been drawn.

For example, a region for carrying out the movement/rotation operation with respect to the superimposed object can be set in advance near an outer circumference of the superimposed object. In this case, for example, when the gesture to draw an ark is made while the region is being touched, the superimposed object can be rotated by an angle in accordance with a length of the ark in a direction in which the ark has been drawn. Further, the superimposed object which is subjected to the dragging operation can be moved while the region is being touched. It is needless to say that aspects of the input operation are not limited to these examples. It is also possible to carry out the input operation through a key operation (a physical key or a software key) without using a gesture.

The above description has shown an example in which a superimposed object is displayed in a web page. Note, however, that content on which the superimposed object is to be displayed is not limited to the web page, provided that the content is displayed in units of pages. For example, the information processing device 1 which is an electronic dictionary can (i) display an image in accordance with data in a format such as an XMDF format and (ii) display a superimposed object so that the superimposed object is superimposed on the displayed image, the superimposed object corresponding to a range specified in the displayed image. Alternatively, the information processing device 1 which is a device capable of displaying an electronic book can (i) display an image in accordance with data in a format such as an EPUB format and (ii) display a superimposed object so that the superimposed object is superimposed on the displayed image, the superimposed object corresponding to a range specified in the displayed image. As in the case of HTML content, such data includes, for example, (i) elements (text and an image or respective reference destinations of the text and the image) constituting the content, (ii) arrangement information for arranging these elements on a screen, and (iii) a tag indicative of a link. This allows a process similar to that of Embodiment 1 to (i) receive, separately from an original web page, an input operation carried out by a user and (ii) display a superimposed object in which a result of the input operation is reflected.

For content other than the web page, a display state in which a superimposed object is displayed can be reproduced by subjecting the content to a process similar to the bookmark process (described earlier) and storing a first piece of information and a second piece of information so that the first piece of information and the second piece of information are associated with each other, the first piece of information being information for accessing the content on which the superimposed object is based, the second piece of information being information indicative of a specified range. For example, some devices for displaying an electronic book or an electronic dictionary have a function of inserting a “bookmark” for displaying content from a page that a user is reading. According to such a device, in a case where an operation to insert the “bookmark” is carried out while a superimposed object is being displayed, it is possible to store a first piece of information and a second piece of information so that the first information and the second piece of information are associated with each other, the first piece of information being information indicative of a page on which the superimposed object being displayed is based, and the second piece of information being information indicative of a range of the superimposed object. When the user carries out an operation to open the page of the “bookmark”, the stored first and second pieces of information can be used not only to display the page into which the “bookmark” has been inserted but also to display the superimposed object so that the superimposed object is superimposed on the page.

Note that the information processing device 1, which basically assumes that a user browses content but does not assume that the user edits the content, may display content that is not to be edited (content that is exclusively used for browsing).

The above description has shown an example in which content (a web page) obtained via a communication network is displayed. Note, however, that a destination from which content is obtained is not particularly limited. For example, content stored in the storage section 200 may be displayed. Alternatively, content obtained from a storage medium such as a memory card which stores therein the content may be displayed by connecting the storage medium to the information processing device 1.

### Embodiment 3

A control block (especially, the control section 100) of the information processing device 1 can be realized by a logic circuit (hardware) provided in an integrated circuit (IC chip) or the like or can be alternatively realized by software as executed by a CPU (Central Processing Unit).

In the latter case, the information processing device 1 includes a CPU that executes instructions of a program that is software realizing the foregoing functions; ROM (Read Only Memory) or a storage device (each referred to as “storage medium”) in which the program and various kinds of data are stored so as to be readable by a computer (or a CPU); and RAM (Random Access Memory) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

### CONCLUSION

A display control device (an information processing device 1) in accordance with Aspect 1 of the present invention is a display control device for displaying, on a display screen in units of pages, content (a web page) containing a link to another content, the display control device including: a receiving section (an operation determination section 10) for receiving an input to specify a range of the displayed content; and a superimposed display section (a superimposed display processing section 12) for, when the receiving section receives the input, displaying a superimposed object so that the superimposed object is superimposed on the content, the superimposed object (i) containing an image displayed in the range specified by the input and (ii) being movable on the display screen.

According to the configuration, the superimposed object containing the image displayed in the specified range in the content is displayed so that the superimposed object is superimposed on the content. This allows a user to display a part of the content so that the part of the content and any other part of the content are displayed so as to be juxtaposed to each other. The user can, for example, display and compare any articles that are juxtaposed to each other in content containing a plurality of articles. Thus, the configuration allows the user to comfortably browse pieces of information which pieces are scattered at different positions in content displayed as a single page. Note that the display screen may be (i) a display screen of a display section provided in the display control device or (ii) a display screen of a display device that is provided separately from the display control device.

Note that the display control device can be referred to as a display control device for displaying content on a display screen in units of pages, the display control device including: a receiving section (an operation determination section 10) for receiving an input to specify a range of the displayed content; and a superimposed display section (a superimposed display processing section 12) for, when the receiving section receives the input, (i) generating reproduced content, which is reproduced from the content (loading the reproduced content into a memory (a superimposed data storing section 34) different from a memory in which the content is loaded) and (ii) displaying a part of the reproduced content so that the part of the reproduced content is superimposed on the content, the part being located within the range specified by the input.

In Aspect 2 of the present invention, the display control device in accordance with Aspect 1 of the present invention further includes a link section (a touch processing section 13) for renewing the image of the superimposed object with an image at a link destination in response to an input to select a link contained in the image of the superimposed object.

According to the configuration, the image of the superimposed object is renewed with the image at the link destination in response to the input to select a link contained in the image of the superimposed object. Thus, (i) the content on which the superimposed object is based and (ii) the image at the link destination can be displayed so as to be juxtaposed to each other. This allows the content to have higher browsability.

In Aspect 3 of the present invention, the display control device in accordance with Aspect 1 or 2 of the present invention further includes a scroll section (a scroll processing section 14) for scroll-displaying the image of the superimposed object in response to an input to scroll-display the superimposed object.

According to the configuration, the image of the superimposed object is scroll-displayed in response to the input to scroll-display the superimposed object. Thus, for example, in a case where no desired image is included in a range that is specified first, or in a case where browsing of an image in the range is finished, the user can display a desired image in the superimposed object by carrying out an input operation to scroll-display the superimposed object.

In Aspect 4 of the present invention, the display control device in accordance with any one of Aspects 1 through 3 of the present invention further includes a storage processing section (a bookmark control section 22) for storing a first piece of information and a second piece of information so that the first piece of information and the second piece of information are associated with each other, the first piece of information being information for accessing the content on which the superimposed object is based, the second piece of information being information indicative of the specified range.

According to the configuration, a first piece of information and a second piece of information are stored so that the first piece of information and the second piece of information are associated with each other, the first piece of information being information for accessing the content on which the superimposed object is based, the second piece of information being information indicative of the specified range. Use of these pieces of information makes it possible not only to display the content on which the superimposed object is based but also to display the superimposed object so that the superimposed object is superimposed on the content. This makes it possible to restore a display state in which the superimposed object is displayed.

In Aspect 5 of the present invention, the display control device in accordance with any one of Aspects 1 through 4 of the present invention further includes a copy section (a copy section 20) for, in response to an input to copy a text contained in the superimposed object, storing the text contained in the superimposed object.

According to the configuration, the text contained in the superimposed object is stored in response to the input to copy the text contained in the superimposed object. This allows the text contained in the superimposed object to be used to, for example, be edited by text editing software.

In Aspect 6 of the present invention, the display control device in accordance with any one of Aspects 1 through 5 of the present invention further includes a range changing section (a deformation section 15) for, in response to an input to change the range, renewing the image of the superimposed object with an image corresponding to the range which has been changed.

According to the configuration, in response to the input to change the range, the image of the superimposed object is renewed with the image corresponding to the range which has been changed. Thus, for example, in a case where no desired image is included in a range that is specified first, or in a case where browsing of an image in the range is finished, the user can display a desired image in the superimposed object by carrying out an input operation to change the range.

In Aspect 7 of the present invention, the display control device in accordance with any one of Aspects 1 through 6 of the present invention further includes a rotation section (a movement processing section 16) for, in response to an input to rotate the superimposed object, rotating the superimposed object and changing a direction of the superimposed object on the display screen.

According to the configuration, in response to the input to rotate the superimposed object, the superimposed object is rotated and the direction of the superimposed object on the display screen is changed. Thus, a user located at a position at which the user cannot see the display screen from the front (e.g., a second user facing, across the display screen, a first user seeing the display screen from the front) can be presented with an image of the superimposed object which image is easy to see.

A display control method in accordance with Aspect 8 of the present invention is a display control method for causing a display control device to display, on a display screen in units of pages, content containing a link to another content, the display control method including: a receiving step of receiving an input to specify a range of the displayed content; and a superimposed display step of, when the input is received in the receiving step, displaying a superimposed object so that the superimposed object is superimposed on the content, the superimposed object (i) containing an image displayed in the range specified by the input and (ii) being movable on the display screen. The display control method yields an effect similar to that yielded by the display control device of Aspect 1 of the present invention.

The display control device in accordance with the foregoing aspects of the present invention may be realized by a computer. In this case, the present invention encompasses: a control program for the display control device which program causes a computer to operate as each section of the display control device so that the display control device can be each realized by the computer; and a computer-readable storage medium storing the control program therein.

The present invention is not limited to the embodiments, but can be altered by a skilled person in the art within the scope of the claims. An embodiment derived from a proper combination of technical means disclosed in respective different embodiments is also encompassed in the technical scope of the present invention. Further, a new technical feature can be obtained by combining technical means disclosed in the embodiments.

### INDUSTRIAL APPLICABILITY

The present invention is applicable to a device for displaying content such as a web page in units of pages.

### REFERENCE SIGNS LIST

1: Information processing device (display control device)
10: Operation determination section (receiving section)
12: Superimposed display processing section (superimposed display section)
13: Touch processing section (link section)
14: Scroll processing section (scroll section)
15: Deformation section (range changing section)
16: Movement processing section (rotation section)
20: Copy section
22: Bookmark control section (storage processing section)

1. A display control device for displaying, on a display screen, content containing a link to another content,
said display control device comprising:
a receiving section for receiving an input to specify a range of the displayed content; and
a superimposed display section for, when the receiving section receives the input, displaying a superimposed object so that the superimposed object is superimposed on the content, the superimposed object (i) containing an image displayed in the range specified by the input and (ii) being movable on the display screen.

2. The display control device as set forth in claim 1, further comprising a link section for renewing the image of the superimposed object with an image at a link destination in response to an input to select a link contained in the image of the superimposed object.

3. The display control device as set forth in claim 1, further comprising a scroll section for scroll-displaying the image of the superimposed object in response to an input to scroll-display the superimposed object.

4. The display control device as set forth in claim 1, further comprising a storage processing section for storing a first piece of information and a second piece of information so that the first piece of information and the second piece of information are associated with each other, the first piece of information being information for accessing the content on which the superimposed object is based, the second piece of information being information indicative of the specified range.

5. The display control device as set forth in claim 1, further comprising a copy section for, in response to an input to copy a text contained in the superimposed object, storing the text contained in the superimposed object.

6. The display control device as set forth in claim 1, further comprising a range changing section for, in response to an input to change the range, renewing the image of the superimposed object with an image corresponding to the range which has been changed.

7. The display control device as set forth in claim 1, further comprising a rotation section for changing a direction of the superimposed object on the display screen in response to an input to rotate the superimposed object.

8. A display control method for causing a display control device to display, on a display screen, content containing a link to another content,
said display control method comprising:
a receiving step of receiving an input to specify a range of the displayed content; and
a superimposed display step of, when the input is received in the receiving step, displaying a superimposed object so that the superimposed object is superimposed on the content, the superimposed object (i) containing an image displayed in the range specified by the input and (ii) being movable on the display screen.

9-10. (canceled)
